(19) United States
(12) Patent Application Publication
(10) Pub. No.: US 2025/0227216 A1
(43) Pub. Date: Jul. 10, 2025

(54) INFORMATION PROCESSING DEVICE AND METHOD

(71) Applicant: SONY GROUP CORPORATION, TOKYO (JP)

(72) Inventors: TOMOYA NAGANUMA, TOKYO (JP); KOJI YANO, TOKYO (JP); WATARU KAWAI, TOKYO (JP); SATORU KUMA, TOKYO (JP); OHJI NAKAGAMI, TOKYO (JP)

(21) Appl. No.: 18/847,128

(22) PCT Filed: Mar. 6, 2023
(86) PCT No.: PCT/JP2023/008228

§ 371 Date: Sep. 13, 2024

(30) Foreign Application Priority Data
Mar. 23, 2022 (JP) 2022-046795

(51) Int. Cl. H04N 13/161; H04N 19/96

(52) U.S. Cl. CPC H04N 13/161; H04N 19/96

(57) ABSTRACT

The present disclosure relates to an information processing device and method capable of suppressing a reduction in efficiency reduction. Reversal processing is performed on a reversal range in a tree structure representing the geometry of point cloud, and encoding is performed on geometry data having the tree structure having been subjected to the reversal processing. Decoding is performed on encoded data of the geometry data of point cloud, and reversal processing is performed on a reversal range in a tree structure representing the geometry of the point cloud, the geometry being included in the geometry data obtained by decoding. The present disclosure can be applied to, for example, an information processing device, an electronic device, an information processing method, or a program.

### TECHNICAL FIELD

The present disclosure relates to an information processing device and method, and more particularly, to an information processing device and method capable of suppressing a reduction in encoding efficiency.

### BACKGROUND ART

Conventionally, an encoding method using an Octree has been devised as an encoding method for geometry data of Point cloud serving as 3D data representing a three-dimensional structure (for example, see NPL 1). NPL 1 discloses a mode and a flag for controlling the resolution of point cloud data represented by the Octree.

### CITATION LIST

### Non Patent Literature

NPL 1
“Information technology. MPEG-I (Coded Representation of Immersive Media). Part 9: Geometry-based Point Cloud Compression”, ISO/IEC 23090-9:2020(E), ISO/IEC JTC 1/SC 29/WG 11

### SUMMARY

### Technical Problem

In the case of this method, however, a node can be deleted in a region including no points but nodes including a leaf node (maximum resolution) are generated in a region including any points. Thus, high-density points may cause lower encoding efficiency than low-density points.

The present disclosure has been devised in view of such circumstances to suppress a reduction in encoding efficiency.

### Solution to Problem

An information processing device according to an aspect of the present technique is an information processing device including: a reversal processing unit that performs reversal processing on a reversal range in a tree structure representing the geometry of point cloud, and an encoding unit that encodes geometry data having the tree structure having been subjected to the reversal processing, wherein the reversal range includes a reversal root node and a descendant node of the reversal root node and is a node range to be subjected to the reversal processing, and the reversal processing is processing that reverses the bit pattern of a leaf node included in the reversal range and associates the bit pattern of a non-leaf node included in the reversal range with the bit pattern of a child node.

An information processing method according to an aspect of the present technique is an information processing method including: performing reversal processing on a reversal range in a tree structure representing the geometry of point cloud, and encoding geometry data having the tree structure having been subjected to the reversal processing, wherein the reversal range includes a reversal root node and a descendant node of the reversal root node and is a node range to be subjected to the reversal processing, and the reversal processing is processing that reverses the bit pattern of a leaf node included in the reversal range and associates the bit pattern of a non-leaf node included in the reversal range with the bit pattern of a child node.

An information processing device according to another aspect of the present technique is an information processing device including: a decoding unit that decodes encoded data of the geometry data of point cloud, and a reversal processing unit that performs reversal processing on a reversal range in a tree structure representing the geometry of the point cloud, the geometry being included in the geometry data obtained by decoding, wherein the reversal range includes a reversal root node and a descendant node of the reversal root node and is a node range to be subjected to the reversal processing, and the reversal processing is processing that reverses the bit pattern of a leaf node included in the reversal range and associates the bit pattern of a non-leaf node included in the reversal range with the bit pattern of a child node.

An information processing method according to another aspect of the present technique is an information processing method including: decoding encoded data of the geometry data of point cloud, and performing reversal processing on a reversal range in a tree structure representing the geometry of the point cloud, the geometry being included in the geometry data obtained by decoding, wherein the reversal range includes a reversal root node and a descendant node of the reversal root node and is a node range to be subjected to the reversal processing, and the reversal processing is processing that reverses the bit pattern of a leaf node included in the reversal range and associates the bit pattern of a non-leaf node included in the reversal range with the bit pattern of a child node.

In the information processing device and method according to an aspect of the present technique, reversal processing is performed on a reversal range in a tree structure representing the geometry of point cloud, and encoding is performed on geometry data having the tree structure having been subjected to the reversal processing. The reversal range includes a reversal root node and a descendant node of the reversal root node. The reversal range is a node range to be subjected to the reversal processing, and the reversal processing is processing that reverses the bit pattern of a leaf node included in the reversal range and associates the bit pattern of a non-leaf node included in the reversal range with the bit pattern of a child node.

In the information processing device and method according to another aspect of the present technique, decoding is performed on encoded data of the geometry data of point cloud, and reversal processing is performed on a reversal range in a tree structure representing the geometry of the point cloud, the geometry being included in the geometry data obtained by decoding. The reversal range includes a reversal root node and a descendant node of the reversal root node and is a node range to be subjected to the reversal processing. The reversal processing is processing that reverses the bit pattern of a leaf node included in the reversal range and associates the bit pattern of a non-leaf node included in the reversal range with the bit pattern of a child node.

### BRIEF DESCRIPTION OF DRAWINGS

FIG. 1 is an explanatory drawing of an example of the voxel representation of geometry.

FIG. 2 is an explanatory drawing illustrating an example of an Octree.

FIG. 3 is an explanatory drawing of dense points.

FIG. 4 is an explanatory drawing showing various methods of bit reversal.

FIG. 5 is an explanatory drawing illustrating an example of reversal processing.

FIG. 6 is an explanatory drawing illustrating an example of a reversal region.

FIG. 7 is an explanatory drawing illustrating an example of a bit reversal flag.

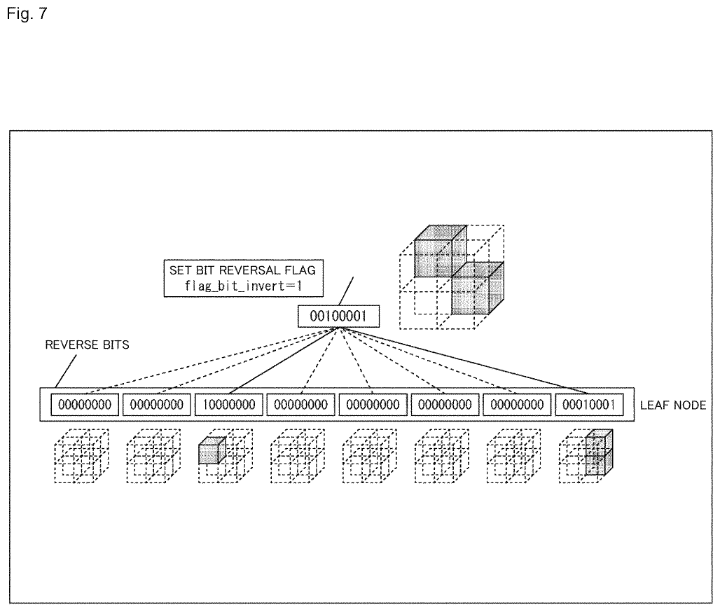

FIG. 8 is an explanatory drawing illustrating an example of a reversal region.

FIG. 9 is an explanatory drawing showing an example of a method for estimating the number of deleted nodes.

FIG. 10 is a block diagram illustrating a main configuration example of a geometry encoding device.

FIG. 11 is a flowchart for describing an example of the flow of geometry encoding processing.

FIG. 12 is a flowchart for describing an example of the flow of bit reversal processing.

FIG. 13 is a flowchart following FIG. 12 illustrating an example of the flow of bit reversal processing.

FIG. 14 is a block diagram illustrating a main configuration example of a geometry decoding device.

FIG. 15 is a flowchart for describing an example of the flow of geometry decoding processing.

FIG. 16 is a flowchart for describing another example of the flow of geometry encoding processing.

FIG. 17 is a flowchart for describing another example of the flow of geometry decoding processing.

FIG. 18 is a block diagram illustrating a main configuration example of a point cloud encoding device.

FIG. 19 is a flowchart for describing an example of the flow of point cloud encoding processing.

FIG. 20 is a block diagram illustrating a main configuration example of a point cloud decoding device.

FIG. 21 is a flowchart for describing an example of the flow of point cloud decoding processing.

FIG. 22 is an explanatory drawing illustrating point cloud of a 3D Occupancy Grid map.

FIG. 23 is an explanatory drawing illustrating the generation of a 3D Occupancy Grid map.

FIG. 24 is an explanatory drawing illustrating the generation of a 3D Occupancy Grid map.

FIG. 25 is an explanatory drawing illustrating the generation of a 3D Occupancy Grid map.

FIG. 26 is an explanatory drawing illustrating an example of point cloud.

FIG. 27 is an explanatory drawing illustrating examples of point cloud.

FIG. 28 is a block diagram illustrating a main configuration example of a 3D Occupancy Grid map encoding device.

FIG. 29 is a flowchart for describing an example of the flow of encoding processing on a 3D Occupancy Grid map.

FIG. 30 is a block diagram illustrating a main configuration example of a 3D Occupancy Grid map decoding device.

FIG. 31 is a flowchart for describing an example of the flow of decoding processing on a 3D Occupancy Grid map.

FIG. 32 is a block diagram illustrating a main configuration example of a computer.

### DESCRIPTION OF EMBODIMENTS

Modes for carrying out the present disclosure (hereinafter referred as embodiments) will be described below. The descriptions will be given in the following order.
1. GPCC
2. Bit reversal of Geometry
3. First Embodiment (Geometry Encoding/Decoding)
4. Second Embodiment (Point Cloud Encoding/Decoding)
5. Third Embodiment (3D Occupancy Grid map)
6. Supplements

### 1. GPCC

### Literature Supporting Technical Contents and Technical Terms

The scope disclosed in the present technique is not limited to the contents described in the embodiments and also includes the contents described in the following NPL and the like that were known at the time of filing and the contents of other literatures referred to in the following NPL.

### [NPL 1]

### Aforementioned

In other words, the contents in the NPL and the contents of other literatures referred to in the foregoing NPL are also grounds for determining support requirements.

### <Point Cloud>

Conventionally, as 3D data representing the three-dimensional structure of a stereoscopic structure (an object having a three-dimensional shape), point cloud representing the object as a set of multiple points has been available. Data of point cloud (also referred to as point cloud data) includes the geometries (position information) and attributes (attribute information) of points constituting the point cloud. The geometry indicates the position of the point in a three-dimensional space. The attribute indicates the attribute of the point. The attribute can include any information. For example, the attribute may include color information, reflectance information, and normal-line information at each point. Thus, the point cloud has a relatively simple data structure and can represent any stereoscopic structure with sufficient accuracy by using a sufficient number of points.

### <Voxel Representation>

However, such point cloud has a relatively large amount of data and thus requires compression of the data amount through encoding or the like. For example, the data amount increases as the geometry of each point increases in the accuracy of position. Accordingly, a method for representing a geometry using a voxel has been examined. A voxel is a region obtained by dividing a three-dimensional space region including an object. The position of each point of point cloud is placed at a predetermined location (e.g., the center) in such a voxel. In other words, the presence or absence of a point in each voxel is represented. Thus, the geometry of each point can be quantized for each voxel. This can suppress an increase in the amount of geometry data. In the present specification, a method for representing geometries using such a voxel will also be referred to as a voxel representation.

One voxel can be divided into a plurality of voxels. Specifically, a repetition of division of voxels in a recursive manner can further downsize the voxels. The smaller the voxel size, the higher the resolution. In short, the position of each point can be represented with higher accuracy. In other words, the effect of reducing the amount of geometry data through quantization is suppressed.

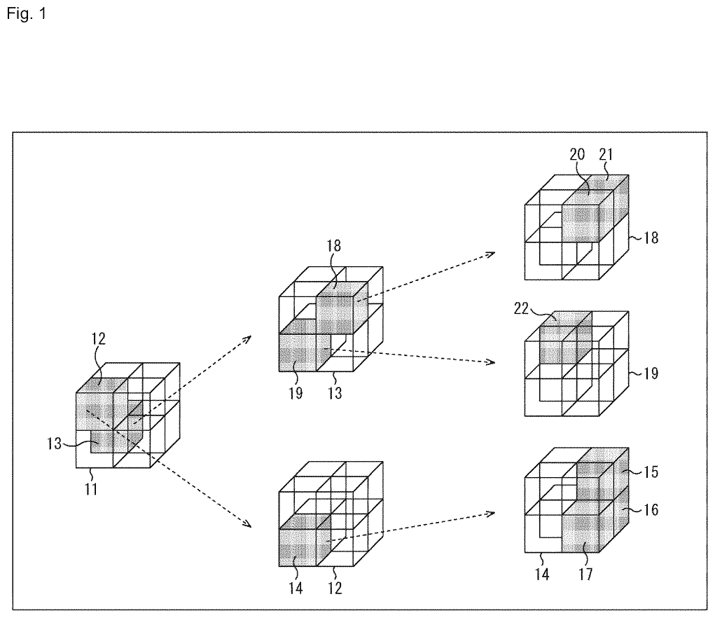

In such a voxel representation of a geometry, only a voxel including a point should be divided to improve the resolution of the geometry. For example, a three-dimensional region 11 in FIG. 1 is assumed to be divided into eight voxels (2×2×2).

In FIG. 1, a gray voxel indicates a voxel including a point. Specifically, the eight voxels of the three-dimensional region 11 include a voxel 12 and a voxel 13 including points.

The voxel 12 can be further divided into eight voxels (2×2×2). The eight voxels include a voxel 14 including a point. The voxel 14 can be further divided into eight voxels (2×2×2). The eight voxels include a voxel 15, a voxel 16, and a voxel 17 including points.

Likewise, the voxel 13 can be further divided into eight voxels (2×2×2). The eight voxels include a voxel 18 and a voxel 19 including points. The voxel 18 can be further divided into eight voxels (2×2×2). The eight voxels include a voxel 20 and a voxel 21 including points. The voxel 19 can be further divided into eight voxels (2×2×2). The eight voxels include a voxel 22 including a point.

For convenience in description, FIG. 1 illustrates the voxels having the same size. In reality, the voxels decrease in size toward the right side (in other word, with a repetition of division) in FIG. 1. In this way, the geometry can be represented using a hierarchical structure in voxel representation.

### <Octree Representation>

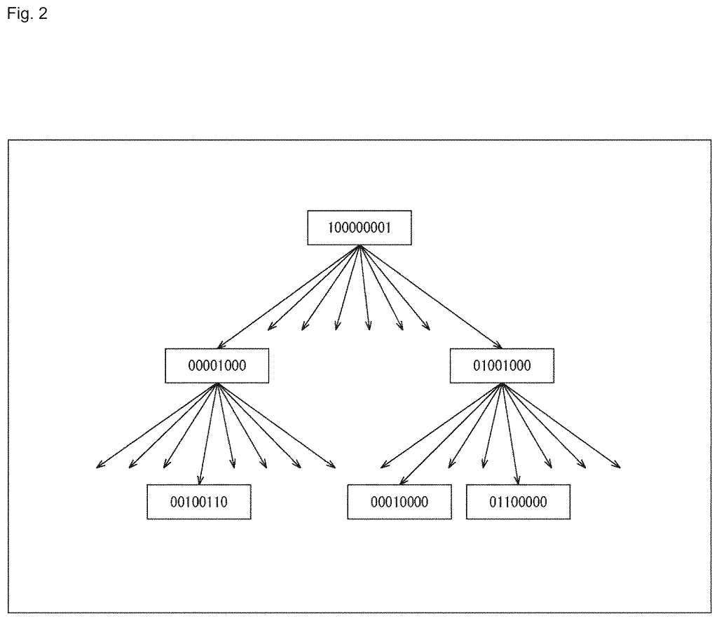

As described above, voxel representation indicates whether each voxel includes a point. Specifically, the voxel of each level serves as a node and the presence or absence of a point in each of the divided voxels is represented as 0 or 1, so that the geometry can be represented as a tree structure as illustrated in FIG. 2. In the example of FIG. 1, one voxel is divided into eight and thus the presence or absence of a point in a voxel at a lower level is represented by an eight-bit pattern at each node. In short, the geometry is represented by an Octree. In the present specification, such a geometry representation method using an Octree is also referred to as Octree representation. The bit patterns of nodes are arranged and encoded in a predetermined order. By using Octree representation, scalable decoding can be achieved for the geometry. In other words, only necessary information can be decoded to obtain a geometry at any level (resolution).

As described above, division of a voxel including no points can be omitted in voxel representation. Thus, also in this Octree representation, a node including no points can be omitted. This can suppress an increase in the amount of geometry data.

In the present specification, a tree structure representing such a geometry will also be referred to as a geometry tree structure. Moreover, the geometry tree structure corresponds to voxel representation and thus will also be referred to as a voxel tree structure.

### <Dense Points>

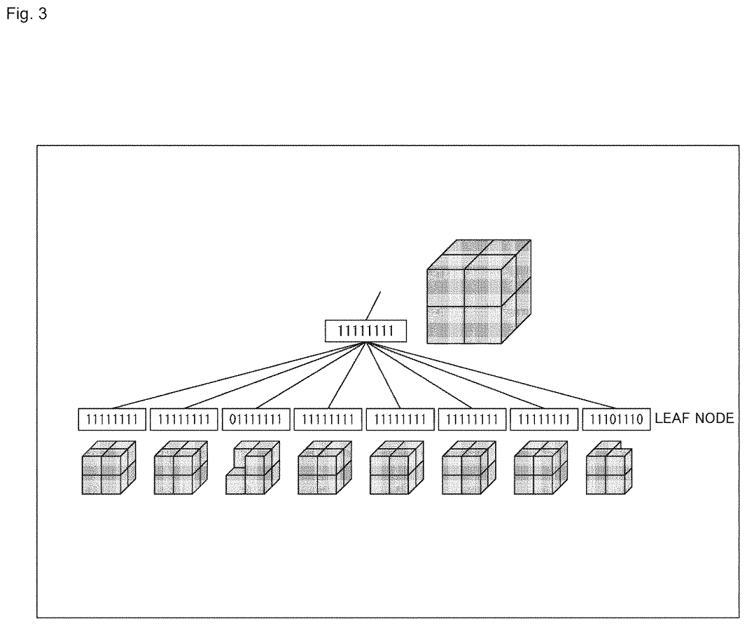

However, for example, in a region including multiple points as illustrated in FIG. 3, points are present in multiple voxels reaching a leaf node (the node of the lowermost layer). Thus, in some cases, the node cannot be omitted. This may increase the amount of encoded data of the geometry (in other words, the encoding efficiency of the geometry may decrease). In the present specification, a state in which multiple points are present will also be referred to as “dense.”

### 2. Bit Reversal of Geometry

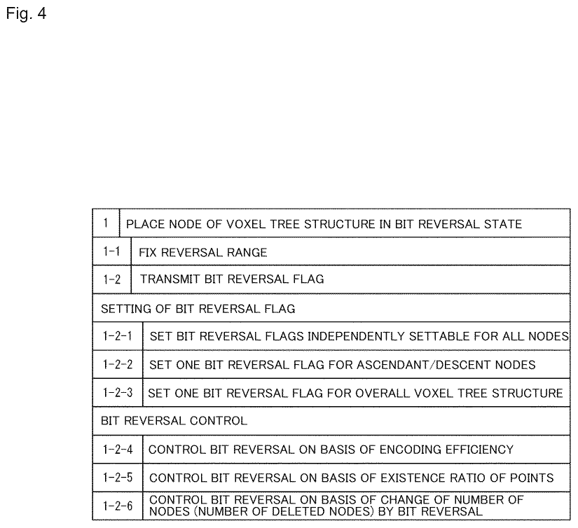

Hence, as indicated in the uppermost row of the table of FIG. 4, some or all the nodes of a voxel tree structure (geometry structure) are allowed to be placed in a bit reversal state (method 1). In the present specification, “bit reversal state” refers to a state in which reversal processing has been performed. “Reversal processing” indicates processing that reverses the bit pattern of a leaf node and associates the bit pattern of the ancestor node (a higher-level node (also referred to as a non-leaf node) where the leaf node belongs) of the leaf node with the bit pattern of a child node. In this case, “bit pattern” refers to a bit pattern indicating the presence or absence of points in voxels at a lower level of a node of the geometry tree structure. “Reversal” refers to processing that converts a bit having a value “0” to a value “1” and converts a bit having a value “1” to a value “0” in a bit pattern. Specifically, for example, a bit pattern of “00110011” is reversed to “11001100.” Moreover, “associates the bit pattern with the bit pattern of a child node” refers to processing in which the value of a bit corresponding to a child node in a bit pattern including a value “1” (that is, a voxel including a point) is set at “1” and the value of a bit corresponding to a child node in a bit pattern with all the bits set at a value “0” (that is, a voxel having not points) is set at “0” among bit patterns of nodes to be processed. In short, such reversal processing can be performed on some or all the nodes of the geometry tree structure.

For example, an information processing device includes a reversal processing unit that performs reversal processing on a reversal range in a tree structure representing the geometry of point cloud, and an encoding unit that encodes geometry data having the tree structure having been subjected to the reversal processing. Moreover, “reversal range” includes a reversal root node and a descendant node of the reversal root node and is configured as a node range to be subjected to reversal processing. Furthermore, “reversal processing” is configured as processing that reverses the bit pattern of a leaf node included in a reversal range and associates the bit pattern of a non-leaf node included in the reversal range with the bit pattern of a child node.

For example, in an information processing method, reversal processing is performed on a reversal range in a tree structure representing the geometry of point cloud, and encoding is performed on geometry data having the tree structure having been subjected to the reversal processing. Moreover, “reversal range” includes a reversal root node and a descendant node of the reversal root node and is configured as a node range to be subjected to reversal processing. Furthermore, “reversal processing” is configured as processing that reverses the bit pattern of a leaf node included in a reversal range and associates the bit pattern of a non-leaf node included in the reversal range with the bit pattern of a child node.

For example, the information processing device includes a decoding unit that decodes encoded data of the geometry data of point cloud, and a reversal processing unit that performs reversal processing on a reversal range in a tree structure representing the geometry of the point cloud, the geometry being included in the geometry data obtained by decoding. Moreover, “reversal range” includes a reversal root node and a descendant node of the reversal root node and is configured as a node range to be subjected to reversal processing. Furthermore, “reversal processing” is configured as processing that reverses the bit pattern of a leaf node included in a reversal range and associates the bit pattern of a non-leaf node included in the reversal range with the bit pattern of a child node.

For example, in the information processing method, decoding is performed on encoded data of the geometry data of point cloud, and reversal processing is performed on a reversal range in a tree structure representing the geometry of the point cloud, the geometry being included in the geometry data obtained by decoding. Moreover, “reversal range” includes a reversal root node and a descendant node of the reversal root node and is configured as a node range to be subjected to reversal processing. Furthermore, “reversal processing” is configured as processing that reverses the bit pattern of a leaf node included in a reversal range and associates the bit pattern of a non-leaf node included in the reversal range with the bit pattern of a child node.

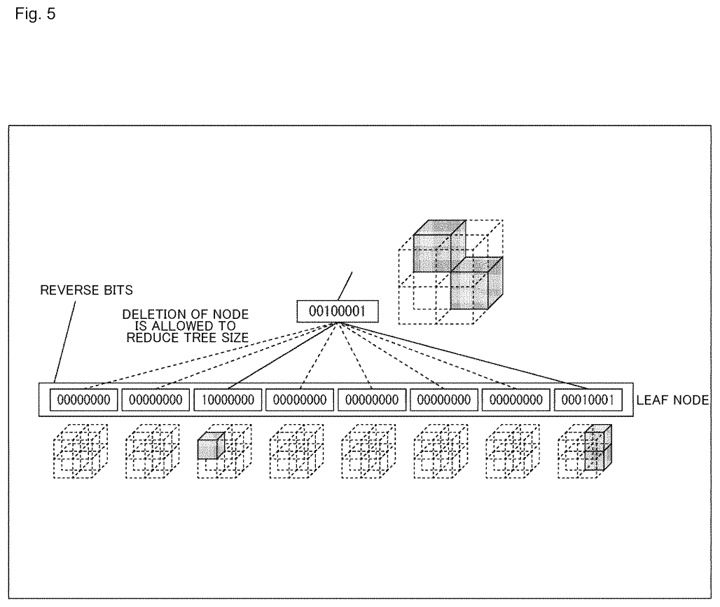

For example, when reversal processing is performed on nodes illustrated in FIG. 3, bit patterns are obtained for the respective nodes as illustrated in FIG. 5. Specifically, in FIG. 5, the bit patterns of leaf nodes other than the third leaf node from the left and the rightmost leaf node are all “0.” Thus, these leaf nodes can be deleted. In other words, the geometry tree structure can be smaller in size than that of the example of FIG. 3. In the present specification, a state in which only a few points are present will also be referred to as “sparse.”

In short, a state of dense points can be represented as a sparse state by performing the reversal processing. Therefore, an increase in the amount of geometry data can be reduced and a reduction in encoding efficiency can be suppressed as compared with the case where reversal processing is not performed.

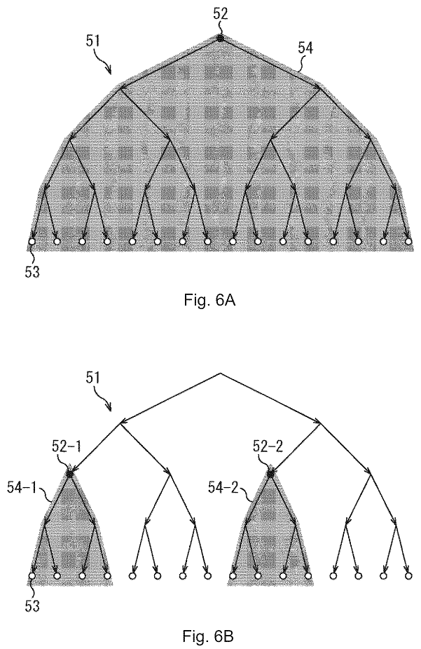

Moreover, any node of the geometry tree structure can be used as a reversal root node. In other words, the reversal range can cover a part of the geometry tree structure or the overall geometry tree structure. For example, as illustrated in A of FIG. 6, a root node (uppermost node) in a geometry tree structure 51 may serve as a reversal root node 52 and a node range including all leaf nodes 53, that is, the overall geometry tree structure 51 may serve as a reversal range 54. Furthermore, as illustrated in B of FIG. 6, an intermediate node (a node other than root nodes and leaf nodes) in the geometry tree structure 51 may serve as a reversal root node 52-1 and a node range including leaf nodes 53 serving as the descendant nodes of the reversal root node, that is, a part of the geometry tree structure 51 may serve as a reversal range 54-1.

As illustrated in B of FIG. 6, a plurality of reversal ranges may be set in a geometry tree structure. For example, in the case of B in FIG. 6, a reversal range 54-1 including the reversal root node 52-1 and a reversal range 54-2 including a reversal root node 52-2 are set in the geometry tree structure 51.

In FIG. 6, the geometry tree structure 51 is illustrated as a binary tree. In A of FIG. 6 and B of FIG. 6, all nodes represented as white circles at the lowest level of the geometry tree structure 51 serve as the leaf nodes 53, though only one of the leaf nodes is denoted by reference numeral (53).

In FIG. 1, the voxels are illustrated as cubes but may have any shapes. For example, the voxels may be rectangular solids. Although one voxel is divided into eight voxels in FIG. 1, the number of divisions (the number of voxels after division) may be any number of divisions. For example, one voxel may be divided into two, four, nine, or 64. It goes without saying that the number of divisions may be different from those of these examples. In other words, the geometry tree structure may have any structure. For example, the geometry tree structure may be an Octree or binary tree structure or other structures.

### <Bit Reversal Flag>

When “method 1” is applied as described above, the reversal range may be fixed (predetermined node range) as indicated in the second row from the top of the table in FIG. 4 (method 1-1). For example, as illustrated in A of FIG. 6, the overall geometry tree structure 51 may serve as a reversal range. Thus, processing for setting the reversal range can be omitted.

Alternatively, the reversal range may be variable. In this case, information about a set reversal range may be transmitted from the encoding side to the decoding side. For example, when “method 1” is applied, a bit reversal flag may be transmitted as indicated in the third row from the top of the table in FIG. 4 (method 1-2).

For example, the information processing device may include a flag setting unit that sets a bit reversal flag for the reversal root node of the reversal range, the bit reversal flag indicating whether to perform reversal processing on a reversal range. The bit reversal flag is information about whether a node corresponding to the flag is a reversal root node or not. In other words, the bit reversal flag is information about whether to perform reversal processing on a reversal range. The reversal range is set such that a node corresponding to the flag serves as a reversal root node.

For example, when the value of the bit reversal flag is “0,” the flag may indicate that reversal processing is not to be performed on a reversal range set such that a node corresponding to the flag serves as a reversal root node. When the value of the bit reversal flag is “1,” the flag may indicate that reversal processing is to be performed on a reversal range set such that a node corresponding to the flag serves as a reversal root node.

For example, the information processing device may further include a reversal control unit that controls whether to perform reversal processing on a reversal range set such that a node to be processed serves as a reversal root node, on the basis of a bit reversal flag corresponding to the node to be processed.

As a result of reversal, the bit patterns of nodes with “sparse” points (=nodes originally with “dense” points) may be all set to 0. In other words, nodes with “sparse” points may be deleted. For example, after reverse processing, the reversal processing unit may delete the nodes of bit patterns indicating sparse points. For example, after reversal processing, the reversal processing unit may delete the nodes of bit patterns all of which are set at 0. In this case, encoding and decoding are irreversible. Moreover, whether points are “sparse” or “dense” is determined by any definition (also referred to as density conditions). For example, “sparse” may be the presence of only a single point, or “sparse” may be the case where the ratio of the number of voxels including points to the total number of voxels is equal to or smaller than a predetermined value. Moreover, only conditions indicating a “sparse” state may be set, only conditions indicating a “dense” state may be set, or the conditions indicating a “sparse” state and the conditions indicating a “dense” state may be set. Furthermore, states other than a “sparse” state may be defined as “dense” states, or states other than “sparse” and “dense” states may be present.

The density conditions may be determined in advance or may be derived on the basis of any kind of information. Moreover, the designation of density conditions (e.g., the designation of a user or an application) may be received from the outside. Furthermore, information about the density conditions may be transmitted from the encoding side to the decoding side. The density conditions may be shared by all the nodes, may vary among the levels of the geometry tree structure, may vary among regions, or may vary among the nodes.

The bit reversal flag may be set for any node. For example, when “method 1-2” is applied, bit reversal flags independently settable for all the non-leaf nodes may be set as indicated in the fifth row from the top of the table in FIG. 4 (method 1-2-1).

For example, the flag setting unit may set bit reversal flags independently for all the nodes of the geometry tree structure.

For example, the reversal control unit may control whether to perform reversal processing on the basis of the bit reversal flags indicating whether to perform reversal processing on a reversal range, the bit reversal flags being set for all the nodes of the geometry tree structure.

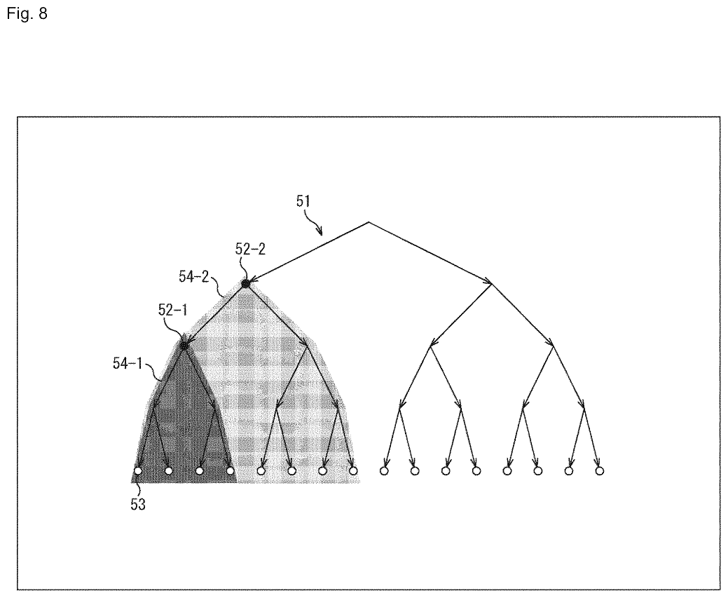

In this case, for example, a plurality of overlapping reversal ranges (the reversal range 54-1 and the reversal range 54-2) can be set as illustrated in FIG. 8. In this case, reversal processing for each of the reversal ranges is performed on a node included in the reversal ranges. In other words, reversal processing is performed multiple times on a node included in the reversal ranges. For example, in the case of FIG. 8, the leaf nodes 53 on the left end is included in the reversal range 54-1 and the reversal range 54-2. Thus, the bit pattern of the leaf nodes 53 is reserved twice.

When “method 1-2” is applied, one bit reversal flag may be set for ascendant/descent nodes (method 1-2-2) as indicated in the sixth row from the top of the table in FIG. 4. The ascendant/descent nodes are nodes (node range) including nodes having an ascendant/descent relationship (parent-child relationship) in the geometry tree structure. In this case, the reversal ranges can be prevented from overlapping each other. Moreover, the bit reversal flag may be set for the first node to be processed, the N-th node to be processed (predetermined N, specified N), or the node to be finally processed.

For example, the flag setting unit may set one bit reversal flag for the ascendant/descent nodes of the geometry tree structure. Furthermore, the reversal control unit may control whether to perform reversal processing, on the basis of the one bit reversal flag set for the ascendant/descent nodes of the geometry tree structure.

When “method 1-2” is applied, a bit reversal flag may be set for the overall voxel tree structure as indicated in the seventh row from the top of the table in FIG. 4 (method 1-2-3). In other words, in this case, the overall geometry tree structure can serve as a reversal range as in the example of A of FIG. 6. Thus, reversal processing can be facilitated.

For example, the flag setting unit may set one bit reversal flag for the overall geometry tree structure. Furthermore, the reversal control unit may control whether to perform reversal processing, on the basis of the one bit reversal flag set for the overall geometry tree structure.

### <Bit Reversal Control>

For example, the information processing device may further include a reversal control unit that controls whether to perform reversal processing. Whether to perform reversal processing is controlled by any method.

When “method 1-2” is applied, bit reversal may be controlled on the basis of encoding efficiency as indicated in the ninth row from the top of the table in FIG. 4 (method 1-2-4). For example, the reversal control unit may control whether to perform reversal processing, on the basis of the encoding efficiency of geometry encoded data. For example, the execution of reversal processing on all settable reversal ranges and the avoidance of reversal processing may be combined, encoding efficiency may be derived for all the patterns, and the pattern with the maximum encoding efficiency may be applied. Thus, encoding can be performed with the maximum encoding efficiency.

When “method 1-2” is applied, bit reversal may be controlled on the basis of the existence ratio of points as indicated in the tenth row from the top of the table in FIG. 4 (method 1-2-5). The existence ratio of points refers to the ratio of voxels including points to all the voxels of a region to be processed. Instead of the existence ratio of points, the number of points included in a region to be processed may be applied. For example, the reversal control unit may control whether to perform reversal processing on the basis of the number of points (or the existence ratio of points) in a reversal range. Specifically, in this case, whether points are “sparse” or “dense” is estimated on the basis of the number of points (or the existence ratio of points). For example, when the number of points (or the existence ratio of points) is equal to or larger than a predetermined threshold value, it may be determined that the points are “dense” and control may be performed to conduct reversal processing. The threshold value may be any value. The threshold value may be shared by all the nodes, may be set for each level, may be set for each region, or may be set for each node. Accordingly, the estimation can be facilitated.

When “method 1-2” is applied, bit reversal may be controlled on the basis of a change of the number of nodes (the number of deleted nodes) by reversal processing as indicated in the lowermost row of the table of FIG. 4 (method 1-2-6). The number of deleted nodes refers to the number of nodes deleted by reversal processing among nodes to be processed and the descendant nodes of the nodes. Instead of the number of deleted nodes, a ratio (the number of deleted nodes/the number of descendant nodes) may be applied. In other words, in this case, a degree of improvement of encoding efficiency is estimated on the basis of the number (or radio) of deleted nodes. For example, the reversal control unit may control whether to perform reversal processing, on the basis of the number of nodes deleted by reversal processing.

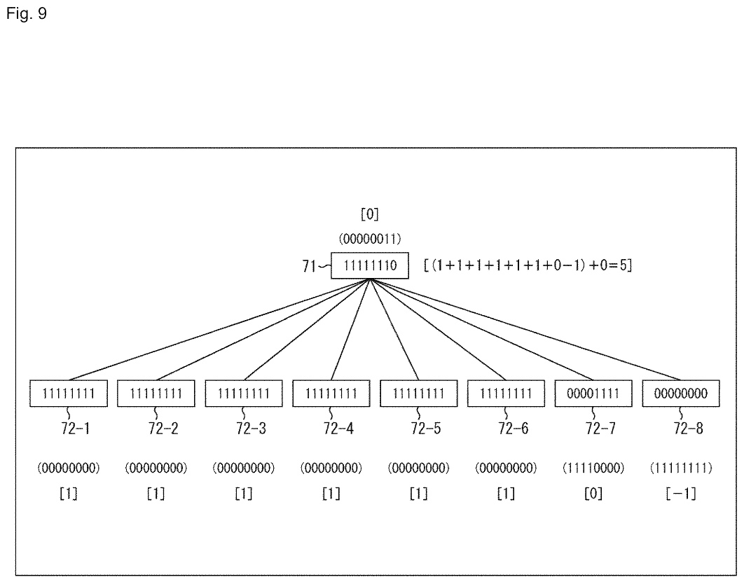

For example, in a geometry tree structure shown in FIG. 9, child nodes (leaf nodes) 72-1 to 72-6 of a node 71 to be processed have a bit pattern “11111111,” a child node 72-7 has a bit pattern “00001111,” and a child node 72-8 has a bit pattern “00000000.” Thus, the node 71 to be processed has a bit pattern “11111110.”

When reversal processing is performed on these nodes serving reversal ranges, the child nodes 72-1 to 72-6 have a bit pattern (00000000). The child node 72-7 has a bit pattern (11110000). The child node 72-8 has a bit pattern “11111111.” Thus, the node 71 to be processed has a bit pattern (00000011).

Therefore, the child nodes 72-1 to 72-6 are deleted after reversal processing and thus the number of deleted nodes is [1]. The child node 72-7 is not deleted even after reversal processing and thus the number of deleted nodes is [0]. The child node 72-8 is added after reversal processing (the node is deleted in a state before reversal processing) and thus the number of deleted nodes is [−1].

The node 71 to be processed is not deleted even after reversal processing. Thus, the number of deleted nodes is [(1+1+1+1+1+1+0−1)+0=5] in the node 71 to be processed.

The larger the number (ratio) of deleted nodes, the lower the encoding efficiency. Thus, for example, control may be performed to conduct reversal processing when the number (or ratio) of deleted nodes is equal to or larger than a predetermined threshold value. The threshold value may be any value. The threshold value may be shared by all the nodes, may be set for each level, may be set for each region, or may be set for each node. Thus, a reduction in encoding efficiency can be more easily suppressed.

Alternatively, reversal processing may be performed after the generation of the nodes in a region including no points in the reversal range. For example, the reversal processing unit may perform reversal processing after the generation of the nodes in a region including no points in the reversal range.

Alternatively, a geometry construction unit may construct the geometry of a three-dimensional space by using a tree structure having been subjected to the reversal processing.

### 3. First Embodiment

### <Geometry Encoding Device>

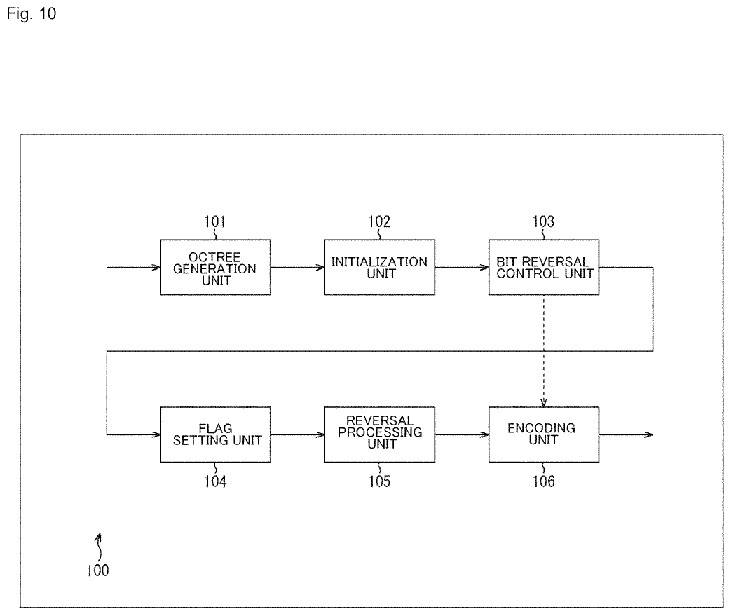

A device to which the present technique is applied in <2. Bit Reversal of Geometry> will be described below. FIG. 10 is a block diagram illustrating a configuration example of a geometry encoding device that is an aspect of an information processing device to which the present technique is applied. A geometry encoding device 100 illustrated in FIG. 10 is a device that encodes the geometry data of point cloud. The geometry encoding device 100 encodes geometry data by applying the present technique described in <2. Bit Reversal of Geometry>. FIG. 10 illustrates principal components such as processing units and data flows, and. FIG. 10 may include other components than the principal components. Specifically, the geometry encoding device 100 may include a processing unit that is not illustrated as a block in FIG. 10 or include processing and data flows that are not indicated as arrows or the like in FIG. 10.

As illustrated in FIG. 10, the geometry encoding device 100 includes an Octree generation unit 101, an initialization unit 102, a bit reversal control unit 103, a flag setting unit 104, a reversal processing unit 105, and an encoding unit 106.

The Octree generation unit 101 generates the Octree of a geometry (geometry tree structure) on the basis of geometry data input to the geometry encoding device 100. The Octree generation unit 101 supplies data on the generated Octree (geometry tree structure) to the initialization unit 102.

The initialization unit 102 acquires the data on the Octree (geometry tree structure) supplied from the Octree generation unit 101. The initialization unit 102 performs processing for initialization. For example, the initialization unit 102 initializes a bit reversal flag (to an initial value (e.g., “0”)) set for the Octree (geometry tree structure). Furthermore, the initialization unit 102 initializes a node to be processed (sets a node to be first processed). At the completion of processing for initialization, the initialization unit 102 supplies data on the Octree (geometry tree structure) and initialized information to the bit reversal control unit 103.

The bit reversal control unit 103 acquires the data on the Octree (geometry tree structure) and the initialized information, the data and information being supplied from the initialization unit 102. The bit reversal control unit 103 performs processing for reversal processing control by using the data and information. For example, the bit reversal control unit 103 determines whether to perform reversal processing (bit reversal) on the node to be processed and performs control. The bit reversal control unit 103 controls an update to the node to be processed. The bit reversal control unit 103 supplies information about the node to be processed to the flag setting unit 104.

The flag setting unit 104 performs processing for setting a flag. For example, the flag setting unit 104 acquires information about the node to be processed, the information being supplied from the bit reversal control unit 103. The flag setting unit 104 properly sets a bit reversal flag for the node to be processed. The flag setting unit 104 supplies information including the node to be processed and a set bit determination flag to the reversal processing unit 105.

The reversal processing unit 105 acquires the information including the node to be processed and the set bit determination flag, the information being supplied from the flag setting unit 104. The reversal processing unit 105 performs reversal processing on the node to be processed. At this point, the reversal processing unit 105 performs reversal processing by applying the present technique described in <2. Bit Reversal of Geometry>. The reversal processing unit 105 supplies information including the result of reversal processing and the bit determination flag to the encoding unit 106.

The encoding unit 106 acquires the information including the result of reversal processing on the node to be processed and the bit determination flag, the information being supplied from the reversal processing unit 105. When acquiring information on all the nodes, the encoding unit 106 encodes geometry data having been subjected to reversal processing and generates geometry encoded data, which is encoded data on a geometry, under the control of the bit reversal control unit 103. The geometry encoded data may include a set bit reversal flag. At this point, the encoding unit 106 performs encoding by applying the present technique described in <2. Bit Reversal of Geometry>. The encoding unit 106 outputs the generated geometry encoded data as the encoding result of the geometry to the outside of the geometry encoding device 100.

Thus, the geometry encoding device 100 can generate encoded data with dense points represented in a sparse state, thereby suppressing a reduction in encoding efficiency.

These processing units (the Octree generation unit 101 to the encoding unit 106) of the geometry encoding device 100 have any configurations. For example, each of the processing units may be configured with a logical circuit that implements the foregoing processing. Furthermore, each of the processing units may include, for example, a CPU (Central Processing Unit), a ROM (Read Only Memory), and a RAM (Random Access Memory), and the foregoing processing may be implemented by executing a program using the CPU, the ROM, and the RAM. It goes without saying that each of the processing units may have both of the configurations, implement part of the processing by means of a logic circuit, and implement the other part of the processing by executing a program. The processing units may have independent configurations, for example, some of the processing units may implement part of the processing by means of a logic circuit, some of the other processing units may implement the processing by executing a program, and the other processing units may implement the processing by a logic circuit and the execution of a program.

### <Flow of Geometry Encoding Processing>

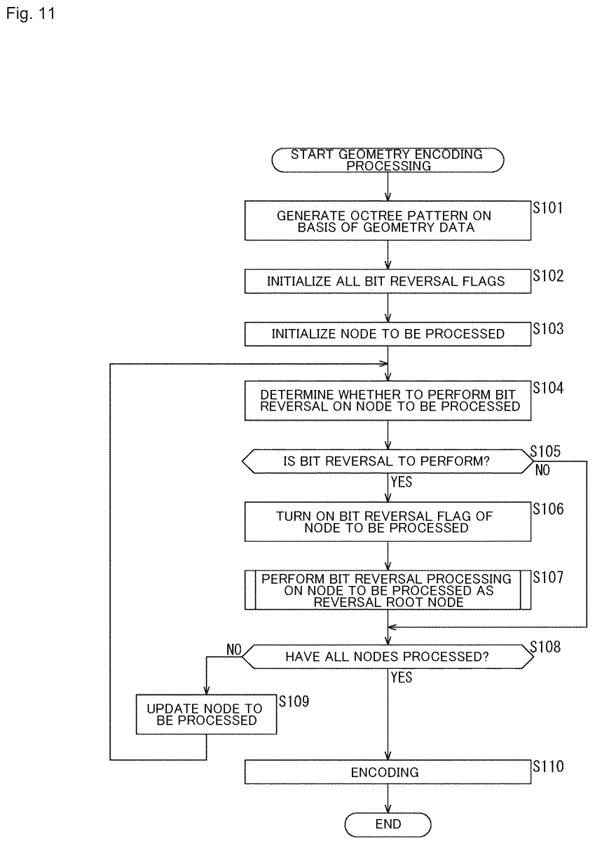

An example of a flow of geometry encoding processing performed by the geometry encoding device 100 will be described below with reference to the flowchart of FIG. 11. In the example of FIG. 11, the method 1-2-1 that sets bit reversal flags independently settable for all the non-leaf nodes is applied.

When geometry encoding processing is started, in step S101, the Octree generation unit 101 generates an Octree pattern (geometry tree structure) on the basis of supplied geometry data.

In step S102, the initialization unit 102 initializes the bit reversal flags of all the bits (for example, to an off-state). In step S103, the initialization unit 102 initializes the node to be processed.

In step S104, the bit reversal control unit 103 determines whether to perform bit reversal on the node to be processed. Specifically, the bit reversal control unit 103 determines whether to perform bit reversal on the node to be processed as a reversal root node. For example, the bit reversal control unit 103 performs the processing by applying “method 1-2-4,” “method 1-2-5,” or “method 1-2-6” of the present technique described in <2. Bit Reversal of Geometry>. When it is determined that bit reversal is to be performed on the node to be processed, the bit reversal control unit 103 advances the processing in step S105 to step S106.

In step S106, the flag setting unit 104 turns on the bit determination flag of the node to be processed.

In step S107, the reversal processing unit 105 performs reversal processing on the node to be processed as a reversal root node. At the completion of the processing of step S107, the processing advances to step S108. When it is determined in step S104 that bit reversal is to be performed on the node to be processed, the bit reversal control unit 103 advances the processing in step S105 to step S108.

In step S108, the bit reversal control unit 103 determines whether all the nodes of the geometry tree structure have been processed. In the presence of an unprocessed node, the processing advances to step S109.

In step S109, the bit reversal control unit 103 updates the node to be processed to a subsequent node. At the completion of the processing of step S109, the processing returns to step S104. Specifically, the processing of steps S104 to S109 is repeatedly performed, and the nodes of the geometry tree structure are processed as nodes to be processed. Thereafter, in step S108, if it is determined that all the nodes of the geometry tree structure have been processed, the processing advances to step S110.

In step S110, the encoding unit 106 encodes geometry data to generate geometry encoded data.

At the completion of the processing of step S110, the geometry encoding processing is terminated.

### (Flow of Bit Reversal Processing)

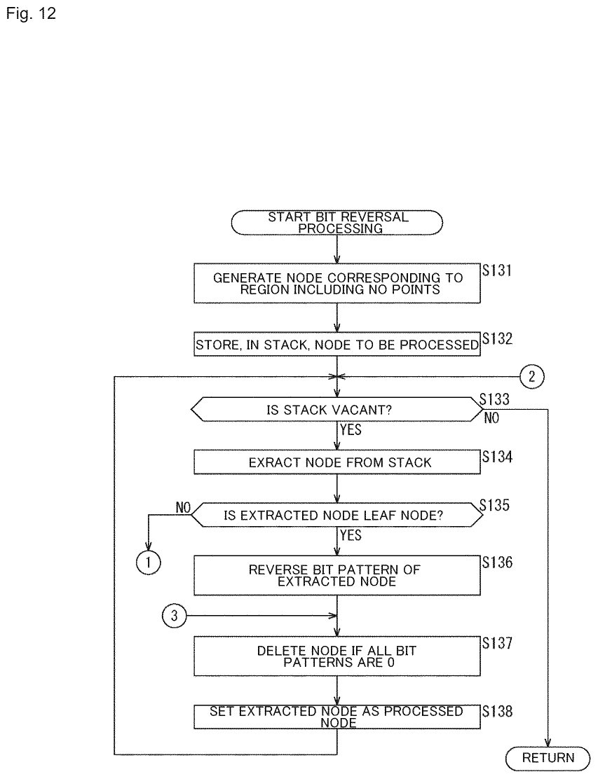

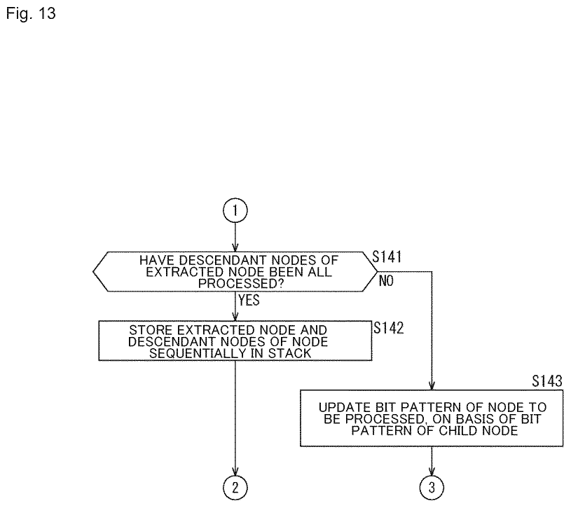

An example of a flow of bit reversal processing performed in step S107 of FIG. 11 will be described below with reference to the flowcharts of FIGS. 12 and 13.

When bit reversal processing is started, in step S131 of FIG. 12, the reversal processing unit 105 generates a node in a region including no points. In step S132, the reversal processing unit 105 stores, in a stack, the node to be processed.

In step S133, the reversal processing unit 105 determines whether the stack is vacant. If it is determined that the stack is not vacant, the processing advances to step S134. In step S134, the reversal processing unit 105 extracts the node from the stack.

In step S135, the reversal processing unit 105 determines whether the extracted node is a leaf node. If it is determined that the node is a leaf node, the processing advances to step S135. In step S136, the reversal processing unit 105 reverses the bit pattern of the extracted node.

In step S137, the reversal processing unit 105 deletes the node if all the bit patterns are 0 after reversal. In step S138, the reversal processing unit 105 sets the extracted node as a processed node. At the completion of the processing of step S138, the processing returns to step S133.

Furthermore, if it is determined in step S135 that the extracted node is a non-leaf node, the processing advances to FIG. 13.

In step S141 of FIG. 13, the reversal processing unit 105 determines whether the descendant nodes of the extracted node have been all processed. If it is determined that unprocessed nodes are present, the processing advances to step S142. In step S142, the reversal processing unit 105 stores the extracted node and the descendant nodes of the node sequentially in the stack. At the completion of the processing of step S142, the processing returns to step S133 of FIG. 12.

If it is determined in step S141 of FIG. 13 that the descendant nodes of the extracted node have been all processed, the processing advances to step S143. In step S143, the reversal processing unit 105 updates the bit pattern of the node to be processed such that the bit pattern corresponds to the bit pattern of the child node. At the completion of the processing of step S143, the processing returns to step S137 of FIG. 12.

The processing performed thus allows the geometry encoding device 100 to suppress a reduction in the encoding efficiency of geometry encoded data.

### <Geometry Decoding Device>

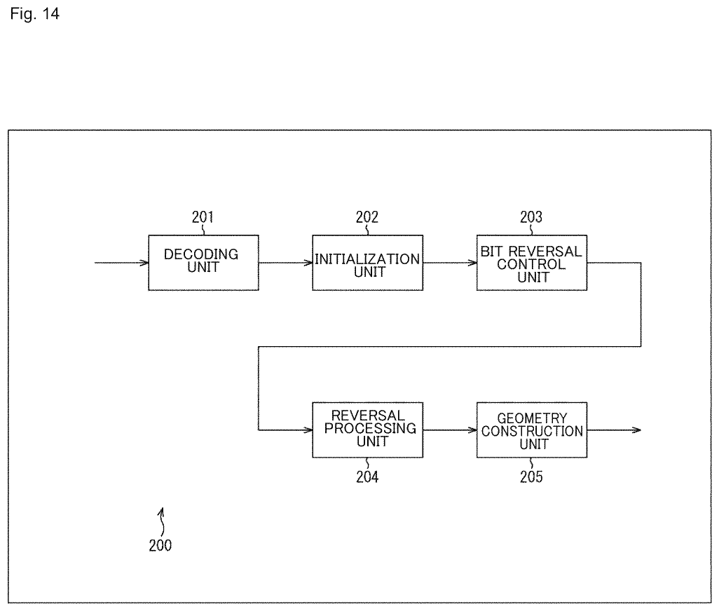

FIG. 14 is a block diagram illustrating a configuration example of a geometry decoding device that is an aspect of an information processing device to which the present technique is applied. A geometry decoding device 200 illustrated in FIG. 14 is a decoding device corresponding to the geometry encoding device 100. The geometry decoding device 200 decodes geometry encoded data and generates geometry data. The geometry decoding device 200 decodes geometry encoded data by applying the present technique described in <2. Bit Reversal of Geometry>.

FIG. 14 illustrates principal components such as processing units and data flows, and FIG. 14 may include other components than the principal components. Specifically, the geometry decoding device 200 may include a processing unit that is not illustrated as a block in FIG. 14 or include processing and data flows that are not indicated as arrows or the like in FIG. 14.

As illustrated in FIG. 14, the geometry decoding device 200 includes a decoding unit 201, an initialization unit 202, a bit reversal control unit 203, a reversal processing unit 204, and a geometry construction unit 205.

The decoding unit 201 acquires geometry encoded data. The decoding unit 201 decodes geometry data and acquires data on an Octree (geometry tree structure) having been properly subjected to reversal processing. The decoding unit 201 supplies the data to the initialization unit 202.

The initialization unit 202 acquires the data on the Octree (geometry tree structure) having been properly subjected to reversal processing, the data being supplied from the decoding unit 201. The initialization unit 202 performs processing for initialization. For example, the initialization unit 202 initializes the node to be processed (sets the node as a node to be first processed). At the completion of the processing for initialization, the initialization unit 202 supplies the data on the Octree (geometry tree structure) and initialized information to the bit reversal control unit 203.

The bit reversal control unit 203 acquires the data on the Octree (geometry tree structure) and the initialized information, the data and information being supplied from the initialization unit 202. The bit reversal control unit 203 performs processing for reversal processing control by using the data and information. For example, the bit reversal control unit 203 determines whether to perform reversal processing (bit reversal) on the node to be processed and performs control. Moreover, the bit reversal control unit 203 controls an update to the node to be processed. The bit reversal control unit 203 supplies information about the node to be processed to the reversal processing unit 204.

The reversal processing unit 204 acquires information about the node to be processed, the information being supplied from the bit reversal control unit 203. The reversal processing unit 204 performs reversal processing on the node to be processed. At this point, the reversal processing unit 204 performs reversal processing by applying the present technique described in <2. Bit Reversal of Geometry>. In other words, the reversal processing unit 204 performs the same processing as the reversal processing unit 105. The reversal processing unit 204 supplies information including the result of reversal processing and the bit determination flag to the geometry construction unit.

The geometry construction unit 205 acquires information including the result of reversal processing on each node to be processed, the information being supplied from the reversal processing unit 204. When information about all the nodes is acquired, the geometry construction unit 205 constructs geometry data on the position of each point in a three-dimensional space by using the data on the Octree (geometry tree structure) having been properly subjected to reversal processing. The geometry construction unit 205 outputs the geometry data as the decoding result of a geometry to the outside of the geometry decoding device 200.

Thus, the geometry decoding device 200 can correctly decode geometry encoded data generated by the geometry encoding device 100. In other words, the geometry decoding device 200 can suppress a reduction in encoding efficiency.

The processing units (the decoding unit 201 to the geometry construction unit 205) of the geometry decoding device 200 have any configurations. For example, each of the processing units may be configured as a logic circuit for implementing the foregoing processing. Moreover, each of the processing units may include, for example, a CPU, a ROM, and a RAM and may implement the processing by executing a program using the CPU, the ROM, and the RAM. It goes without saying that each of the processing units may have both of the configurations, implement part of the processing by means of a logic circuit, and implement the other part of the processing by executing a program. The processing units may have independent configurations, for example, some of the processing units may implement part of the processing by means of a logic circuit, some of the other processing units may implement the processing by executing a program, and the other processing units may implement the processing by a logic circuit and the execution of a program.

### <Flow of Geometry Decoding Processing>

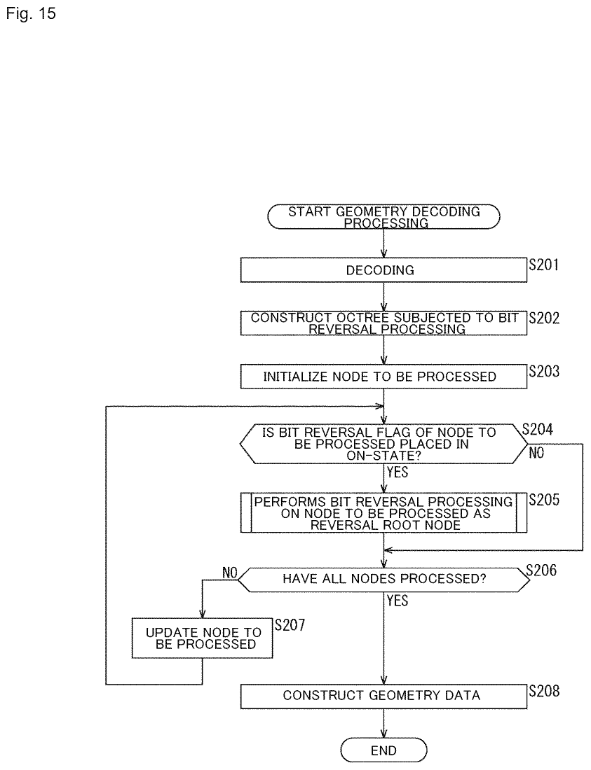

An example of a flow of geometry decoding processing performed by the geometry decoding device 200 will be described below with reference to the flowchart of FIG. 15. In the example of FIG. 15, the method 1-2-1 that sets bit reversal flags independently settable for all the non-leaf nodes is applied.

When geometry decoding processing is started, in step S201, the decoding unit 201 decodes supplied geometry encoded data. The decoding unit 201 constructs an Octree by using the decoding result on the basis of step S202 and generates data on the Octree (geometry tree structure) having been properly subjected to reversal processing.

In step S203, the initialization unit 202 initializes the node to be processed.

In step S204, the bit reversal control unit 103 determines whether the bit reversal flag of the node to be processed is placed in an on-state. If it is determined that the bit reversal flag of the node to be processed is placed in an on-state, the processing advances to step S205.

In step S205, the reversal processing unit 204 performs reversal processing on the node to be processed as a reversal root node. The flow of reverse processing is similar to that described with reference to the flowcharts of FIGS. 12 and 13. At the completion of the processing of step S205, the processing advances to step S206. If it is determined in step S204 that the bit reversal flag of the node to be processed is placed in an off-state, the processing advances to step S206.

In step S206, the bit reversal control unit 203 determines whether all the nodes of the geometry tree structure have been processed. In the presence of an unprocessed node, the processing advances to step S207.

In step S207, the bit reversal control unit 203 updates the node to be processed to a subsequent node. At the completion of the processing of step S207, the processing returns to step S204. Specifically, the processing of steps S204 to S209 is repeatedly performed, and the nodes of the geometry tree structure are processed as nodes to be processed. Thereafter, in step S206, if it is determined that all the nodes of the geometry tree structure have been processed, the processing advances to step S208.

In step S208, the geometry construction unit 205 constructs geometry data on the position of each point in a three-dimensional space by using data on the Octree (geometry tree structure) having been properly subjected to reversal processing.

At the completion of the processing of step S208, the geometry decoding processing is terminated.

The processing performed thus allows the geometry decoding device 200 to correctly decode geometry encoded data generated by the geometry encoding device 100. In other words, the geometry decoding device 200 can suppress a reduction in the encoding efficiency of geometry decoded data.

### <Flow of Geometry Encoding Processing>

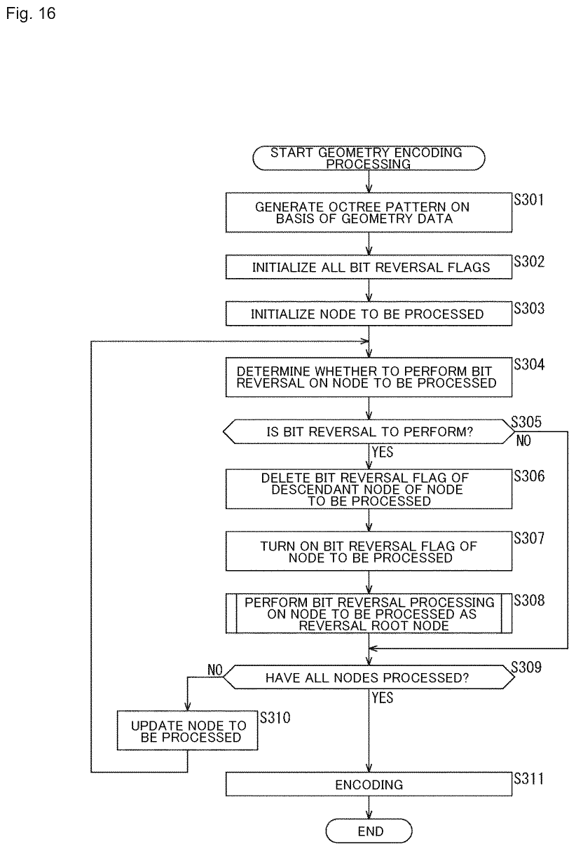

An example of the flow of geometry encoding processing using the method 1-2-2, in which a single bit reversal flag is set for ascendant/descent nodes, will be described below with reference to the flowchart of FIG. 16.

When the geometry encoding processing is started, the processing of steps S301 to S305 is performed like the processing of steps S101 to S105 of FIG. 11. If it is determined in step S305 that reversal processing is to be performed on the node to be processed as a reversal root node, the processing advances to step S306.

In step S306, the flag setting unit 104 deletes the bit determination flag of the descendant nodes of the node to be processed. At the completion of the processing of step S306, the processing advances to step S307.

The processing of steps S307 to S311 is performed like the processing of steps S106 to S110 of FIG. 11. At the completion of the processing of step S311, the geometry encoding processing is terminated.

The processing is performed thus. Also in this case, the geometry encoding device 100 can suppress a reduction in the encoding efficiency of geometry encoded data.

### <Flow of Geometry Decoding Processing>

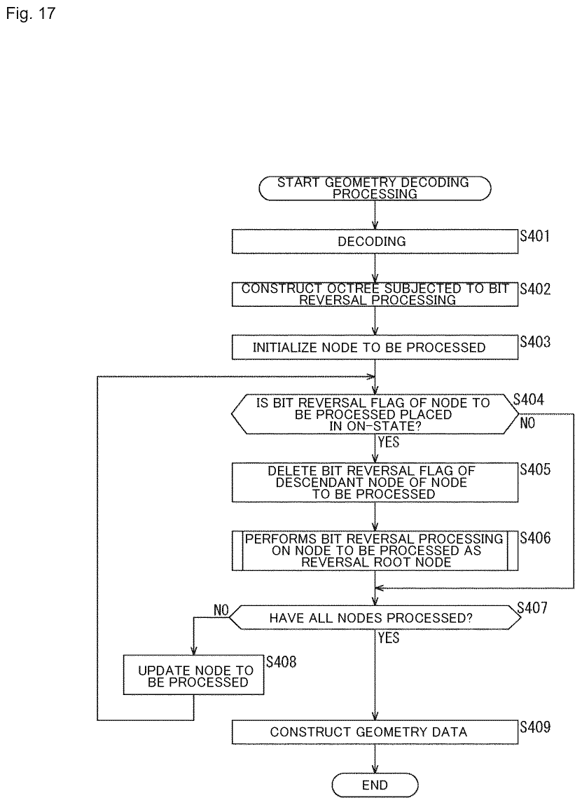

An example of the flow of geometry decoding processing using the method 1-2-2, in which a single bit reversal flag is set for ascendant/descent nodes, will be described below with reference to the flowchart of FIG. 17.

When the geometry decoding processing is started, the processing of steps S401 to S404 is performed like the processing of steps S201 to S204 of FIG. 15. If it is determined in step S404 that the bit reversal flag of the node to be processed is placed in an on-state, the processing advances to step S405.

In step S405, the bit reversal control unit 203 deletes the bit determination flag of the descendant nodes of the node to be processed. At the completion of the processing of step S405, the processing advances to step S406.

The processing of steps S406 to S409 is performed like the processing of steps S205 to S208 of FIG. 15. At the completion of the processing of step S409, the geometry decoding processing is terminated.

The processing is performed thus. Also in this case, the geometry decoding device 200 to correctly decode geometry encoded data generated by the geometry encoding device 100. In other words, the geometry decoding device 200 can suppress a reduction in the encoding efficiency of geometry decoded data.

### 4. Second Embodiment

### <Point Cloud Encoding Device>

The present technique described in <2. Bit Reversal of Geometry> is applicable to any device as well as the example of the first embodiment. For example, the present technique can be also applied to a point cloud encoding device that encodes point cloud data.

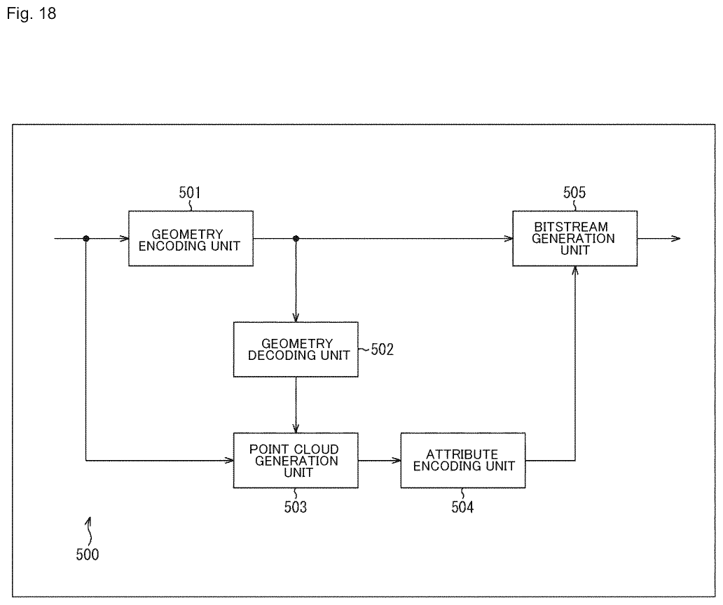

FIG. 18 is a block diagram illustrating a configuration example of a point cloud encoding device that is an aspect of an information processing device to which the present technique is applied. A point cloud encoding device 500 illustrated in FIG. 18 is a device that encodes point cloud data. The point cloud encoding device 500 encodes point cloud data by applying the present technique described in <2. Bit Reversal of Geometry>.

FIG. 18 illustrates principal components such as processing units and data flows, and FIG. 18 may include other. components than the principal components. Specifically, the point cloud encoding device 500 may include processing units that are not illustrated as blocks in FIG. 18 and processing and data flows that are not illustrated as arrows or the like in FIG. 18.

As illustrated in FIG. 18, the point cloud encoding device 500 includes a geometry encoding unit 501, a geometry decoding unit 502, a point cloud generation unit 503, an attribute encoding unit 504, and a bitstream generation unit 505.

The geometry encoding unit 501 performs processing for encoding of geometry data. For example, the geometry encoding unit 501 acquires the geometry encoded data of point cloud data input to the point cloud encoding device 500. The geometry encoding unit 501 encodes the geometry encoded data to generate encoded data. At this point, the geometry encoding unit 501 encodes the geometry data by applying the present technique described in <2. Bit Reversal of Geometry>. In other words, the geometry encoding unit 501 has the same configuration as the geometry encoding device 100 (FIG. 10) and performs the same processing. The geometry encoding unit 501 supplies the generated the geometry encoded data to the geometry decoding unit 502 and the bitstream generation unit 505.

The geometry decoding unit 502 performs processing for decoding of geometry encoded data. For example, the geometry decoding unit 502 acquires geometry encoded data supplied from the geometry encoding unit 501. The geometry decoding unit 502 decodes the encoded data according to a decoding method corresponding to an encoding method applied in the geometry encoding unit 501 and generates (restores) geometry data. In other words, the geometry decoding unit 502 decodes the geometry encoded data by applying the present technique described in <2. Bit Reversal of Geometry>. In short, the geometry decoding unit 502 has the same configuration as the geometry decoding device 200 (FIG. 14) and performs the same processing. The geometry decoding unit 502 supplies the generated geometry data to the point cloud generation unit 503.

The point cloud generation unit 503 performs processing for generation of point cloud data. For example, the point cloud generation unit 503 acquires attribute data of point cloud data input to the point cloud encoding device 500. Furthermore, the point cloud generation unit 503 acquires geometry data supplied from the geometry decoding unit 502.

Geometry data may be changed by processing such as encoding and decoding (for example, points may increase or decrease or move). Specifically, geometry data supplied from the geometry decoding unit 502 may be different from geometry data to be encoded by the geometry encoding unit 501.

Thus, the point cloud generation unit 503 performs processing (also referred to as recoloring processing) for matching attribute data to geometry data (decoding result). Specifically, the point cloud generation unit 503 updates attribute data in response to an update to geometry data. The point cloud generation unit 503 supplies the updated attribute data (attribute data corresponding to geometry data (decoding result)) to the attribute encoding unit 504.

The attribute encoding unit 504 performs processing for attribute encoding. For example, the attribute encoding unit 504 acquires attribute data supplied from the point cloud generation unit 503. Furthermore, the attribute encoding unit 504 encodes the attribute data by any method to generate encoded data of the attribute data. Any encoding method may be used. The attribute encoding unit 504 supplies the generated encoded data of the attribute data to the bitstream generation unit 505.

The bitstream generation unit 505 performs processing for generation of a bitstream. For example, the bitstream generation unit 505 acquires the geometry encoded data supplied from the geometry encoding unit 501. Furthermore, the bitstream generation unit 505 acquires the encoded data of the attribute data, the encoded data being supplied from the attribute encoding unit 504. The bitstream generation unit 505 generates a bitstream including the encoded data. The bitstream generation unit 505 outputs the generated bitstream to the outside of the point cloud encoding device 500.

With this configuration, the point cloud encoding device 500 can suppress a reduction in the encoding efficiency of geometry encoded data.

Each of the processing units (the geometry encoding unit 501 to the bitstream generation unit 505) of the point cloud encoding device 500 has any configuration. For example, each of the processing units may be configured as a logic circuit for implementing the foregoing processing. Moreover, each of the processing units may include, for example, a CPU, a ROM, and a RAM and may implement the processing by executing a program using the CPU, the ROM, and the RAM. It goes without saying that each of the processing units may have both of the configurations, implement part of the processing by means of a logic circuit, and implement the other part of the processing by executing a program. The processing units may have independent configurations, for example, some of the processing units may implement part of the processing by means of a logic circuit, some of the other processing units may implement the processing by executing a program, and the other processing units may implement the processing by a logic circuit and the execution of a program.

### <Flow of Point Cloud Encoding Processing>

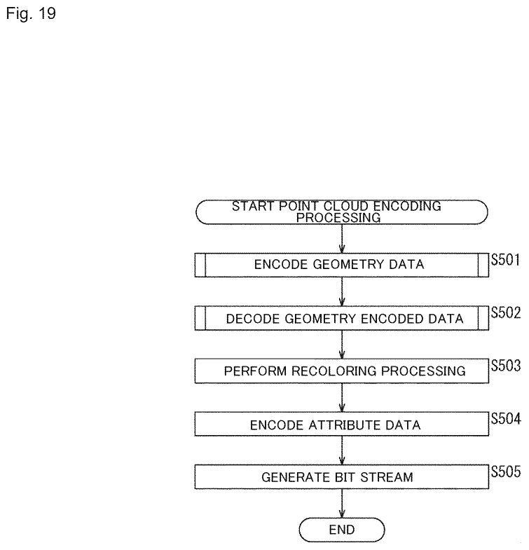

The point cloud encoding device 500 encodes point cloud data by performing point cloud encoding processing. An example of a flow of the point cloud encoding processing will be described below with reference to the flowchart of FIG. 19.

When point cloud encoding processing is started, in step S501, the geometry encoding unit 501 performs geometry encoding processing to encode geometry data and generates geometry encoded data. The flow of the geometry encoding processing is similar to that described with reference to the flowchart of FIG. 11 or 16.

In step S502, the geometry decoding unit 502 performs geometry decoding processing to decode the geometry encoded data generated in step S501 and generates (restores) the geometry data. The flow of the geometry decoding processing is similar to that described with reference to the flowchart of FIG. 15 or 17.

In step S503, the point cloud generation unit 503 performs recoloring processing to associate attribute data with the geometry data generated in step S502.

In step S504, the attribute encoding unit 504 encodes the attribute data recolored in step S503.

In step S505, the bitstream generation unit 505 generates a bitstream including the generated encoded data of the geometry data in step S501 and the generated encoded data of the attribute data in step S504.

At the completion of the processing of step S505, the point cloud encoding processing is terminated.

The processing performed thus allows the point cloud encoding device 500 to suppress a reduction in the encoding efficiency of geometry encoded data.

### <Point Cloud Decoding Device>

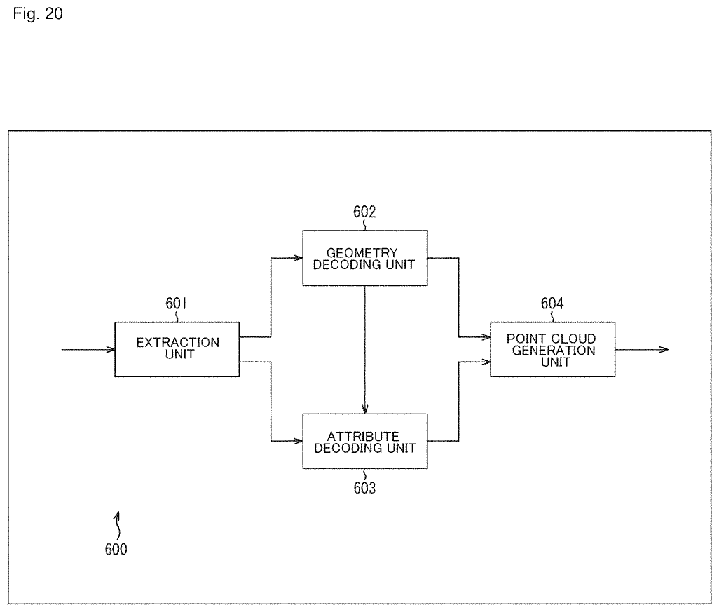

FIG. 20 is a block diagram illustrating a configuration example of a point cloud decoding device that is an aspect of an information processing device to which the present technique is applied. A point cloud decoding device 600 illustrated in FIG. 20 is a decoding device corresponding to the point cloud encoding device 500. The point cloud decoding device 600 decodes the bit stream of point cloud and generates point cloud data. The point cloud decoding device 600 decodes the bit stream of point cloud by applying the present technique described in <2. Bit Reversal of Geometry>.

FIG. 20 illustrates principal components such as processing units and data flows, and FIG. 20 may include other components than the principal components. Specifically, the point cloud decoding device 600 may include processing units that are not illustrated as blocks in FIG. 20 and processing and data flows that are not illustrated as arrows or the like in FIG. 20.

As illustrated in FIG. 20, the point cloud decoding device 600 includes an extraction unit 601, a geometry decoding unit 602, an attribute decoding unit 603, and a point cloud generation unit 604.

The extraction unit 601 extracts geometry encoded data from a bit stream and supplies the bit stream to the geometry decoding unit 602. Furthermore, the extraction unit 601 extracts attribute encoded data from the bit stream and supplies the attribute encoded data to the attribute decoding unit 603.

The geometry decoding unit 602 performs processing for decoding of geometry encoded data. For example, the geometry decoding unit 602 acquires geometry encoded data supplied from the extraction unit 601 and decodes the data to generate (restore) geometry data. At this point, the geometry decoding unit 602 decodes the geometry data by applying the present technique described in <2. Bit Reversal of Geometry>. In other words, the geometry decoding unit 602 has the same configuration as the geometry decoding device 200 (FIG. 14) and performs the same processing. The geometry decoding unit 602 supplies the generated geometry data to the attribute decoding unit 603 and the point cloud generation unit 604.

The attribute decoding unit 603 performs processing for decoding of attribute encoded data. For example, the attribute decoding unit 603 acquires attribute encoded data supplied from the extraction unit 601. Moreover, the attribute decoding unit 603 acquires geometry data supplied from the geometry decoding unit 602. The attribute decoding unit 603 decodes the attribute encoded data by using the geometry data and generates (restores) attribute data.

The attribute decoding unit 603 performs decoding according to a decoding method corresponding to the encoding method used by the attribute encoding unit 504 (FIG. 18). The attribute decoding unit 603 supplies the generated attribute data to the point cloud generation unit 604.

The point cloud generation unit 604 performs processing for generation of point cloud. For example, the point cloud generation unit 604 acquires geometry data supplied from the geometry decoding unit 602. Furthermore, the point cloud generation unit 604 acquires attribute data supplied from the attribute decoding unit 603. Thereafter, the point cloud generation unit 604 associates the geometry data with the attribute data to generate point cloud data. The point cloud generation unit 604 outputs the generated point cloud data to the outside of the point cloud decoding device 600.

With this configuration, the point cloud decoding device 600 can correctly decode the bit stream generated by the point cloud encoding device 500. I other words, the point cloud decoding device 600 can suppress a reduction in encoding efficiency.

Each of the processing units (the extraction unit 601 to the point cloud generation unit 604) of the point cloud decoding device 600 has any configuration. For example, each of the processing units may be configured as a logic circuit for implementing the foregoing processing. Moreover, each of the processing units may include, for example, a CPU, a ROM, and a RAM and may implement the processing by executing a program using the CPU, the ROM, and the RAM. It goes without saying that each of the processing units may have both of the configurations, implement part of the processing by means of a logic circuit, and implement the other part of the processing by executing a program. The processing units may have independent configurations, for example, some of the processing units may implement part of the processing by means of a logic circuit, some of the other processing units may implement the processing by executing a program, and the other processing units may implement the processing by a logic circuit and the execution of a program.

### <Flow of Point Cloud Decoding Processing>

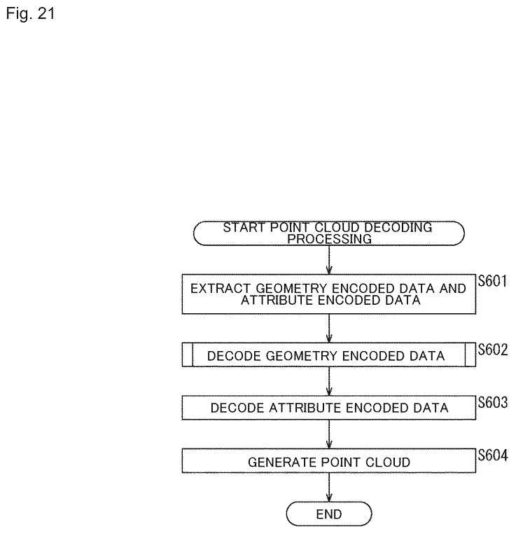

The point cloud decoding device 600 decodes a bit stream by performing point cloud decoding processing. An example of the flow of the point cloud decoding processing will be described below with reference to the flowchart of FIG. 21.

When point cloud decoding processing is started, in step S601, the extraction unit 601 extracts geometry encoded data and attribute encoded data from a bit stream.

In step S602, the geometry decoding unit 602 performs geometry decoding processing to decode the geometry encoded data and generates (restores) geometry data. The flow of the geometry decoding processing is similar to that described with reference to the flowchart of FIG. 15 or 17.

In step S603, the attribute decoding unit 603 decodes the attribute encoded data to generate (restore) attribute data.

In step S604, the point cloud generation unit 604 generates point cloud data by associating the geometry data generated in step S602 with the attribute data generated in step S603.

At the completion of the processing of step S604, the point cloud decoding processing is terminated.

The processing performed thus allows the point cloud decoding device 600 to correctly decode the bit stream generated by the point cloud encoding device 500. I other words, the point cloud decoding device 600 can suppress a reduction in encoding efficiency.

### 5. Third Embodiment

### <3D Occupancy Grid Map>

For example, Japanese Patent Application Publication No. 2021-071814 discloses a method of expressing point group data, which represents a three-dimensional space, as a 3D Occupancy Grid map (for example, see a paragraph numbered [0003] or [0073]).

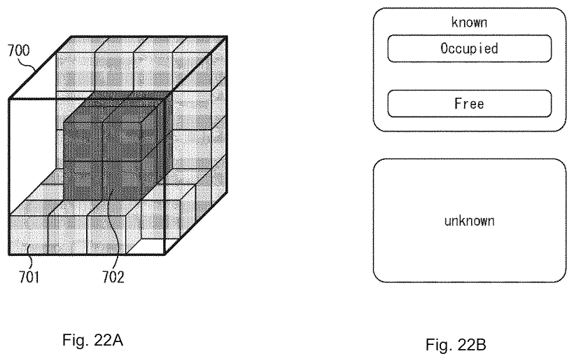

In a 3D Occupancy Grid map, for example, a three-dimensional space 700 is divided into predetermined grids as illustrated in A of FIG. 22. Each of the grids is assigned with an occupied state (a discrete occupied state). Specifically, each of the grids is identified as being observed or unobserved (known/unknown) and being occupied or unoccupied (Occupied/Free). Observed grids (known) are identified as an Occupied 701 that is a grid occupied by an object and a Free 702 that is a grid including no objects. In short, the grids are identified as shown in B of FIG. 22.

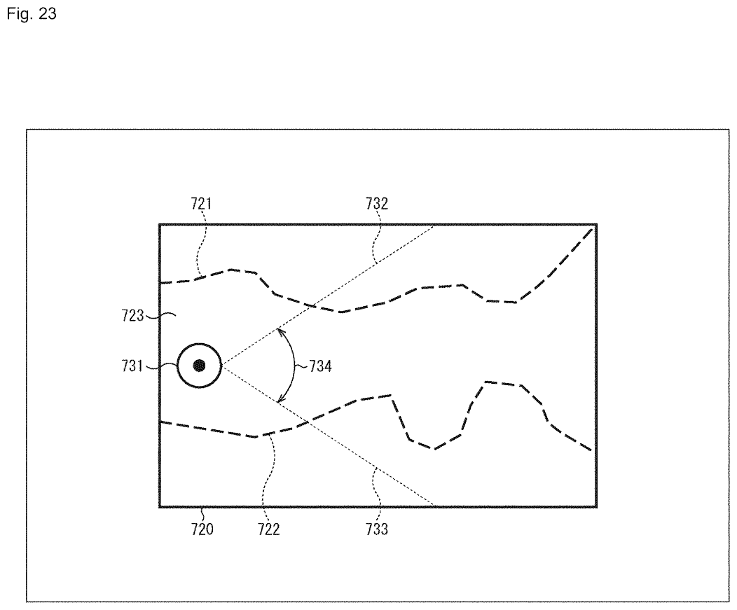

For example, as illustrated in FIG. 23, it is assumed that a region 720 includes a space 723 interposed between a wall 721 and a wall 722. It is assumed that a robot 731 having a camera or a range sensor is caused to travel in the space 723 to generate a 3D Occupancy Grid map. It is assumed that the robot 731 has a measurable range 734 between a dotted line 732 and a dotted line 733.

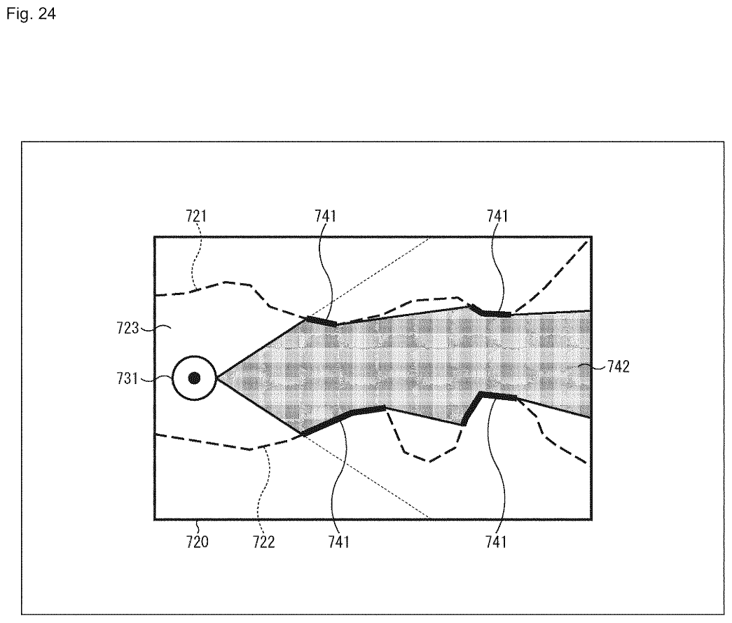

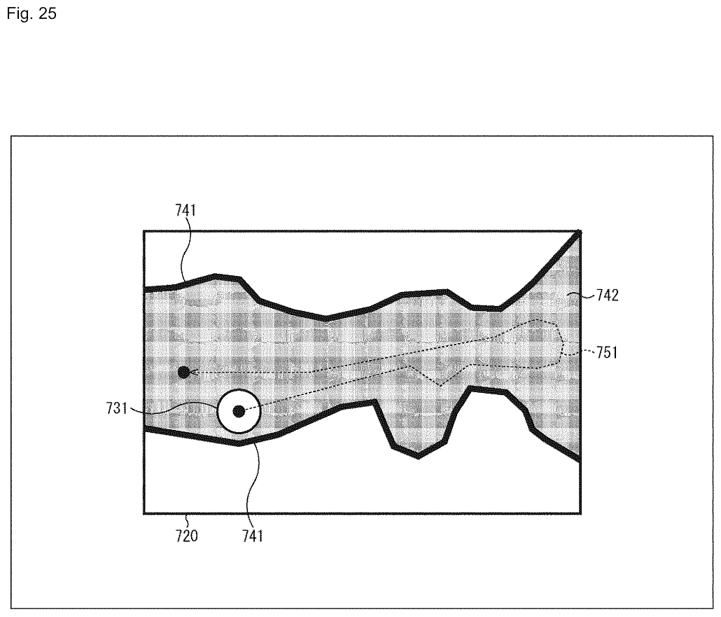

As illustrated in FIG. 24, the robot 731 identifies thick-line parts as the occupied 741 on the wall 721 and the wall 722 in the measurable range 734, and identifies a gray region as the free 742 in the space 723. Other parts are identified as being unknown. As illustrated in FIG. 25, the robot 731 travels to identify the wall 721 and the wall 722 as the occupied 741 and identifies the space 723 as the free 742.

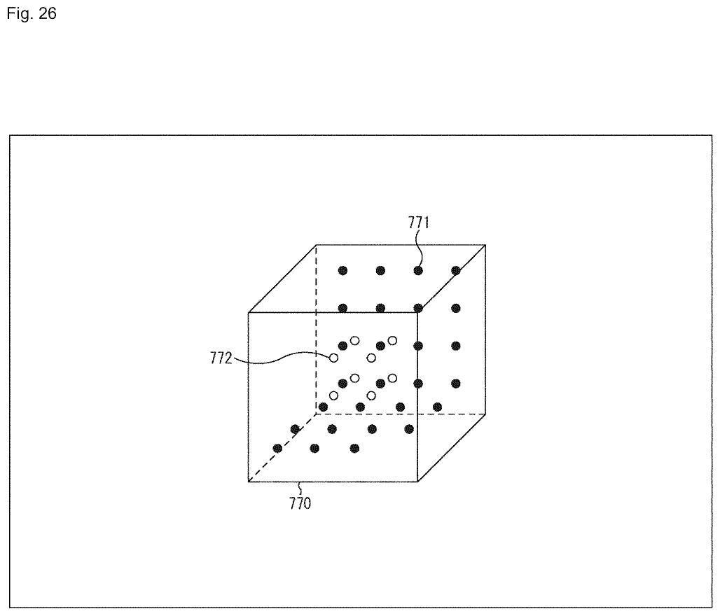

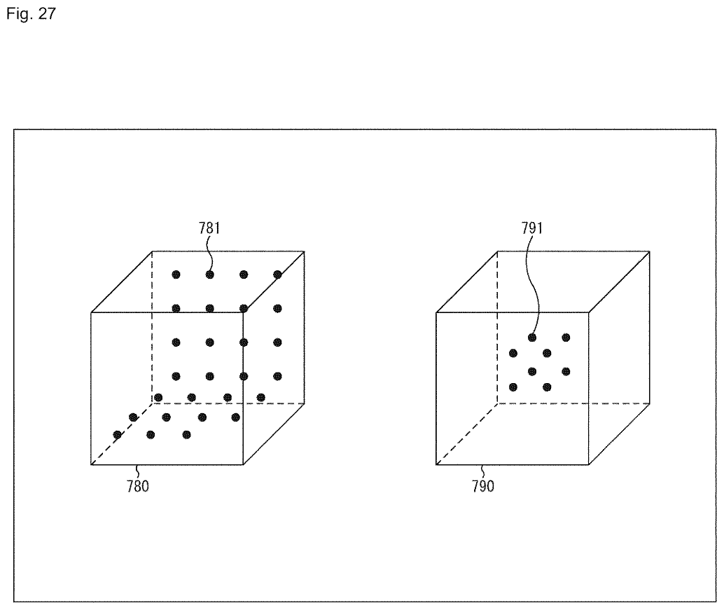

These grids may be transformed into point cloud and encoded. For example, as illustrated in FIG. 26, known grids may be identified as point cloud 770, and occupied 771 and free 772 are identified using attributes. Furthermore, as illustrated in FIG. 27, point cloud 780 including occupied 781 as points and point cloud 790 including free 791 as points may be produced. Furthermore, point cloud including Known as points and point cloud including occupied as points may be produced. Moreover, point cloud including free as points and point cloud including Unknown as points may be produced. Any other combinations may also be used.

The free, occupied, known, and unknown are likely to have a high density. Thus, the present technique described in <2. Bit Reversal of Geometry> may be applied to encoding and decoding of the point cloud (geometry).

### <3D Occupancy Grid Map Encoding Device>

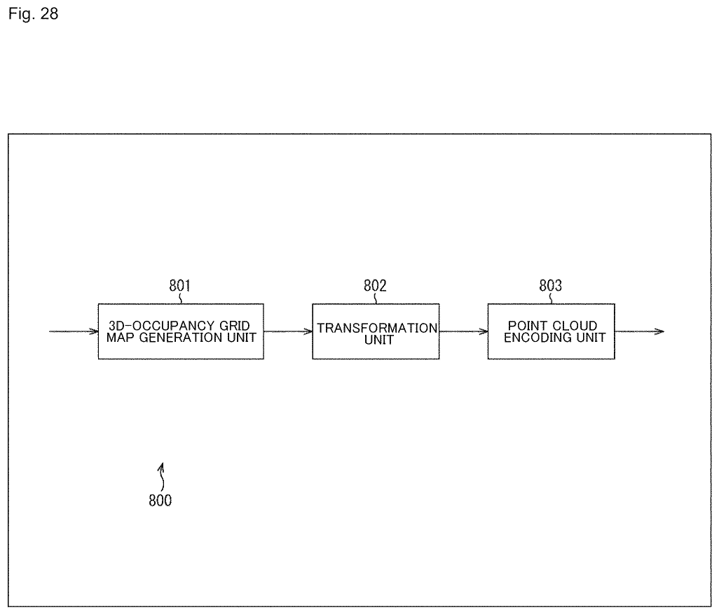

FIG. 28 is a block diagram illustrating a main configuration example of a 3D Occupancy Grid map encoding device that transforms a 3D Occupancy Grid map into point cloud and encodes the point cloud. As illustrated in FIG. 28, a 3D Occupancy Grid map encoding device 800 includes a 3D Occupancy Grid map generation unit 801, a transformation unit 802, and a point cloud encoding unit 803.

The 3D Occupancy Grid map generation unit 801 generates a 3D Occupancy Grid map and supplies the map to the transformation unit 802. The transformation unit 802 transforms the 3D Occupancy Grid map into point cloud and supplies the point cloud to the point cloud encoding unit 803.

The point cloud encoding unit 803 encodes the point cloud to generate a bit stream. At this point, the point cloud encoding unit 803 encodes the point cloud by applying the present technique described in <2. Bit Reversal of Geometry>. In other words, the point cloud encoding unit 803 has the same configuration as the point cloud encoding device 500 (FIG. 18) and performs the same processing. The point cloud encoding unit 803 outputs the generated bitstream to the outside of the 3D Occupancy Grid map encoding device 800.

With this configuration, the 3D Occupancy Grid map encoding device 800 can suppress a reduction in the encoding efficiency of geometry encoded data for point cloud transformed from a 3D Occupancy Grid map.

Each of the processing units (the 3D Occupancy Grid map generation unit 801 to the point cloud encoding unit 803) of the 3D Occupancy Grid map encoding device 800 has any configuration. For example, each of the processing units may be configured as a logic circuit for implementing the foregoing processing. Moreover, each of the processing units may include, for example, a CPU, a ROM, and a RAM and may implement the processing by executing a program using the CPU, the ROM, and the RAM. It goes without saying that each of the processing units may have both of the configurations, implement part of the processing by means of a logic circuit, and implement the other part of the processing by executing a program. The processing units may have independent configurations, for example, some of the processing units may implement part of the processing by means of a logic circuit, some of the other processing units may implement the processing by executing a program, and the other processing units may implement the processing by a logic circuit and the execution of a program.

### <Flow of Encoding Processing on 3D Occupancy Grid Map>

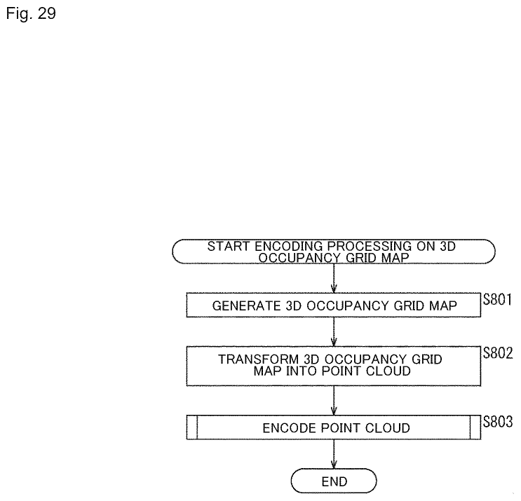

The 3D Occupancy Grid map encoding device 800 performs encoding processing on a 3D Occupancy Grid map, so that the 3D Occupancy Grid map is transformed into point cloud and is encoded. An example of a flow of encoding processing on a 3D Occupancy Grid map will be described below with reference to the flowchart of FIG. 29.

When encoding processing on the 3D Occupancy Grid map is started, in step S801, the 3D Occupancy Grid map generation unit 801 generates a 3D Occupancy Grid map. In step S802, the transformation unit 802 transforms the 3D Occupancy Grid map into point cloud. In step S803, the point cloud encoding unit 803 performs point cloud encoding processing to encode the point cloud and generates a bit stream. The flow of the point cloud encoding processing is similar to that described with reference to the flowchart of FIG. 19. When the bit stream is generated, the encoding processing on the 3D Occupancy Grid map is terminated.

The processing performed thus allows the 3D Occupancy Grid map encoding device 800 to suppress a reduction in the encoding efficiency of geometry encoded data for point cloud transformed from a 3D Occupancy Grid map.

### <3D Occupancy Grid Map Decoding Device>

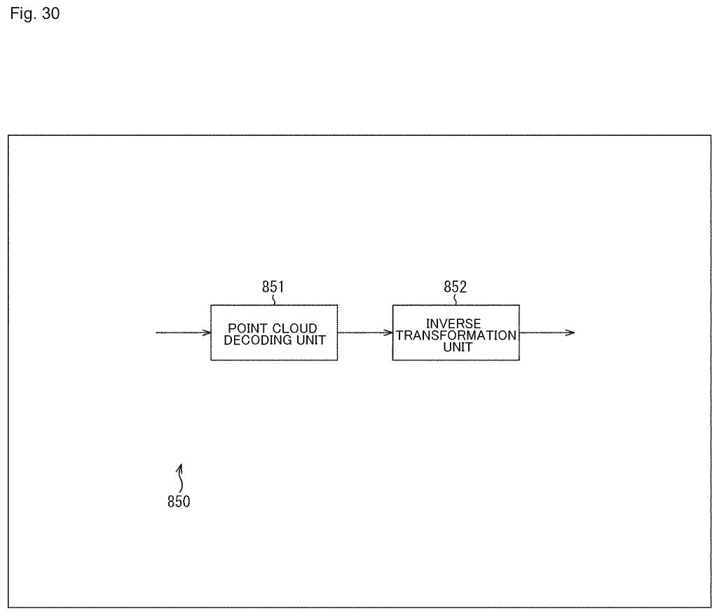

FIG. 30 is a block diagram illustrating a main configuration example of a 3D Occupancy Grid map decoding device that generates (restores) a 3D Occupancy Grid map by decoding the bit stream of the 3D Occupancy Grid map, which has been transformed into point cloud and encoded, and performing inverse transformation. As illustrated in FIG. 30, a 3D Occupancy Grid map decoding device 850 includes a point cloud decoding unit 851 and an inverse transformation unit 852.

The point cloud decoding unit 851 decodes a supplied bit stream to generate (restore) point cloud data converted from a 3D Occupancy Grid map. The point cloud decoding unit 851 supplies the point cloud data to the inverse transformation unit 852.

The inverse transformation unit 852 acquires the point cloud data. The inverse transformation unit 852 transforms the acquired point cloud data into a 3D Occupancy Grid map. The transformation is also referred to as inverse transformation. The inverse transformation unit 852 outputs the 3D Occupancy Grid map obtained by inverse transformation to the outside of the 3D Occupancy Grid map decoding device 850.

With this configuration, the 3D Occupancy Grid map decoding device 850 can correctly decode the bit stream generated by the 3D Occupancy Grid map encoding device 800. In other words, the 3D Occupancy Grid map decoding device 850 can suppress a reduction in the encoding efficiency of geometry encoded data for point cloud transformed from a 3D Occupancy Grid map.

Each of the processing units (the point cloud decoding unit 851 and the inverse transformation unit 852) of the 3D Occupancy Grid map decoding device 850 has any configuration. For example, each of the processing units may be configured as a logic circuit for implementing the foregoing processing. Moreover, each of the processing units may include, for example, a CPU, a ROM, and a RAM and may implement the processing by executing a program using the CPU, the ROM, and the RAM. It goes without saying that each of the processing units may have both of the configurations, implement part of the processing by means of a logic circuit, and implement the other part of the processing by executing a program. The processing units may have independent configurations, for example, some of the processing units may implement part of the processing by means of a logic circuit, some of the other processing units may implement the processing by executing a program, and the other processing units may implement the processing by a logic circuit and the execution of a program.

### <Flow of Decoding Processing on 3D Occupancy Grid Map>

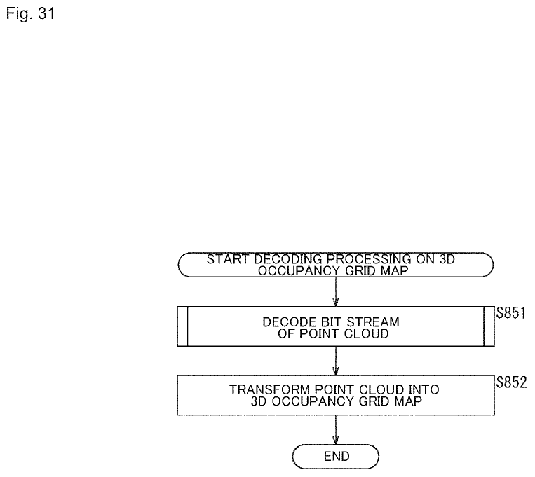

The 3D Occupancy Grid map decoding device 850 decodes a bit stream by performing decoding processing on a 3D Occupancy Grid map. An example of a flow of decoding processing on a 3D Occupancy Grid map will be described below with reference to the flowchart of FIG. 31.

When decoding processing on a 3D Occupancy Grid map is started, in step S851, the point cloud decoding unit 851 performs point cloud decoding processing, so that a bit stream is decoded to generate (restore) point cloud data transformed from a 3D occupancy grip map. The flow of the point cloud decoding processing is similar to that described with reference to the flowchart of FIG. 21.

In step S852, the inverse transformation unit 852 transforms the point cloud data into a 3D Occupancy Grid map. At the completion of the processing of step S852, decoding processing on the 3D Occupancy Grid map is terminated.

The processing performed thus allows the 3D Occupancy Grid map decoding device 850 to correctly decode the bit stream generated by the 3D Occupancy Grid map encoding device 800. In other words, the D Occupancy Grid map decoding device 850 can suppress a reduction in the encoding efficiency of geometry encoded data for point cloud transformed from a 3D Occupancy Grid map.

### 6. Supplements

### <Computer>

The above-described series of processing can be executed by hardware or software. When the series of processing is executed by software, a program that constitutes the software is installed on a computer. In this case, the computer includes, for example, a computer built in dedicated hardware and a general-purpose personal computer on which various programs are installed to enable various functions.

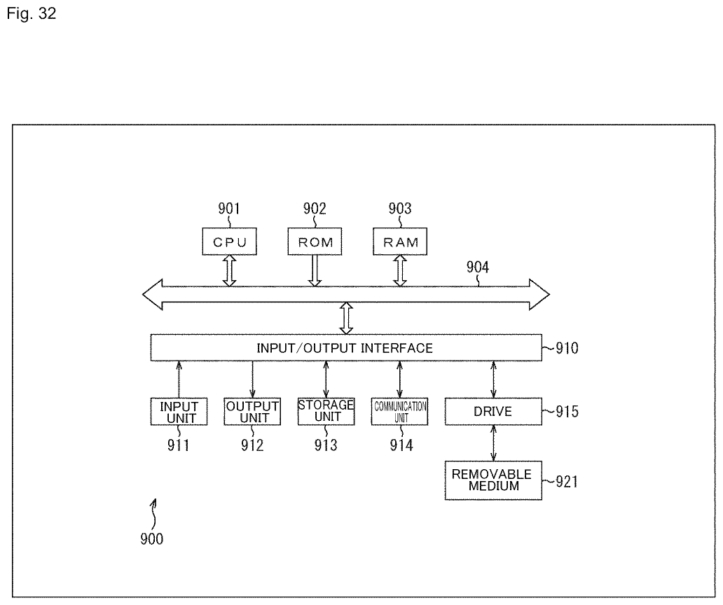

FIG. 32 is a block diagram showing an example of a hardware configuration of a computer that executes the series of processing according to a program.

In a computer 900 illustrated in FIG. 32, a CPU (Central Processing Unit) 901, a ROM (Read Only Memory) 902, and a RAM (Random Access Memory) 903 are connected to one another via a bus 904.

An input/output interface 910 is also connected to the bus 904. An input unit 911, an output unit 912, a storage unit 913, a communication unit 914, and a drive 915 are connected to the input/output interface 910.

The input unit 911 includes, for example, a keyboard, a mouse, a microphone, a touch panel, or an input terminal. The output unit 912 includes, for example, a display, a speaker, or an output terminal. The storage unit 913 includes, for example, a hard disk, a RAM disk, and non-volatile memory. The communication unit 914 includes, for example, a network interface. The drive 915 drives a removable medium 921 such as a magnetic disk, an optical disc, a magneto-optical disk, or a semiconductor memory.

In the computer configured as described above, the CPU 901 loads a program stored in the storage unit 913 into the RAM 903 via the input/output interface 910 and the bus 904 and executes the program, so that the series of processing is performed. Data and the like necessary for the CPU 901 to execute the various kinds of processing is also stored as appropriate in the RAM 903.

The program executed by the computer can be recorded in, for example, the removable medium 921 as a package medium or the like and provided in such a form. In such a case, the program can be installed in the storage unit 913 via the input/output interface 910 by inserting the removable medium 921 into the drive 915.

This program can also be provided via wired or wireless transfer medium such as a local area network, the Internet, and digital satellite broadcasting. In such a case, the program can be received by the communication unit 914 and installed in the storage unit 913.

In addition, this program can be installed in advance in the ROM 902 or the storage unit 913.

### Application Target of Present Technique

The present technique can be applied to any configuration. For example, the present technique can be applied to a variety of electronic devices.

Additionally, for example, the present technique can be implemented as a configuration of a part of a device such as a processor (e.g., a video processor) of a system Large Scale Integration (LSI) circuit, a module (e.g., a video module) using a plurality of processors or the like, a unit (e.g., a video unit) using a plurality of modules or the like, or a set (e.g., a video set) with other functions added to the unit.

For example, the present technique can also be applied to a network system configured with a plurality of devices. The present technique may be implemented as, for example, cloud computing for processing shared among a plurality of devices via a network. For example, the present technique may be implemented in a cloud service that provides services regarding images (moving images) to any terminals such as a computer, an Audio Visual (AV) device, a mobile information processing terminal, and an Internet of Things (IoT) device or the like.

In the present specification, a system means a set of a plurality of constituent elements (devices, modules (parts) or the like) regardless of whether all the constituent elements are placed in the same casing. Accordingly, a plurality of devices accommodated in separate casings and connected via a network and a single device accommodating a plurality of modules in a single casing are all referred to as a system.

### Fields and Applications to which Present Technique is Applicable

A system, device, a processing unit, and the like to which the present technique is applied can be used in any field such as traffic, medical treatment, security, agriculture, livestock industries, a mining industry, beauty, factories, home appliance, weather, and natural surveillance, for example. The application of the present technique can also be implemented as desired.

### Others

Note that “flag” in the present specification is information for identifying a plurality of states and includes not only information used to identify two states of true (1) or false (0) but also information that allows identification of three or more states. Therefore, a value that can be indicated by “flag” may be, for example, a binary value of 1 or 0 or may be ternary or larger. In other words, the number of bits constituting “flag” may be any number, e.g., 1 bit or a plurality of bits. It is also assumed that the identification information (also including a flag) is included in a bit stream or the difference information of identification information with respect to certain reference information is included in a bit stream. Thus, “flag” and “identification information” in the present specification include not only the information but also the difference information with respect to the reference information.

Various kinds of information (such as metadata) related to coded data (bitstream) may be transmitted or recorded in any form as long as the information is associated with coded data. For example, the term “associate” means that when one data is processed, the other may be used (may be associated). In other words, mutually associated items of data may be integrated into one item of data or may be individual items of data. For example, information associated with coded data (image) may be transmitted through a transmission path that is different from that for the coded data (image). For example, the information associated with the coded data (image) may be recorded in a recording medium that is different from that for the coded data (image) (or a different recording area in the same recording medium). “Associate” may correspond to part of data instead of the entire data. For example, an image and information corresponding to the image may be associated with a plurality of frames, one frame, or any unit such as a part in the frame.

In the present specification, terms such as “synthesize”, “multiplex”, “add”, “integrate”, “include”, “store”, “put in”, “enclose”, and “insert” may mean, for example, combining a plurality of objects into one, such as combining coded data and metadata into one piece of data, and means one method of “associating” described above.

Embodiments of the present technique are not limited to the above-described embodiments and can be changed in various ways within the scope of the present technique without departing from the gist of the present technique.

For example, a configuration described as one device (or processing unit) may be split into and configured as a plurality of devices (or processing units). Conversely, configurations described above as a plurality of devices (or processing units) may be integrated and configured as one device (or processing unit). It is a matter of course that configurations other than the aforementioned configurations may be added to the configuration of each device (or each processing unit). Moreover, some of configurations of a certain device (or processing unit) may be included in a configuration of another device (or another processing unit) as long as the configurations and operations of the overall system are substantially identical to one another.

For example, the aforementioned program may be executed by any device. In this case, the device only needs to have necessary functions (such as functional blocks) to obtain necessary information.

Furthermore, for example, each step of one flowchart may be executed by one device, or may be shared and executed by a plurality of devices. Moreover, when a plurality of processing steps are included in one step, one device may execute the plurality of processing steps, or the plurality of devices may share and execute the plurality of processing steps. In other words, it is also possible to execute the plurality of processing steps included in one step as processing of a plurality of steps. Reversely, processing described as a plurality of steps can be collectively executed as one step.

Furthermore, for example, in a program that is executed by a computer, processing of steps describing the program may be executed in time series in the order described in the present specification, or may be executed in parallel or individually at a required timing, for example, when a call is made. In other words, the processing of steps may be executed in an order different from the above-described order if no contradiction arises. Furthermore, the processing of steps describing this program may be executed in parallel with processing of another program, or may be executed in combination with the processing of another program.

Moreover, for example, a plurality of techniques regarding the present technique can be independently implemented if no contradiction arises. As a matter of course, any number of techniques regarding the present technique can also be implemented in combination. For example, the present technique described in any one of the embodiments may be implemented partially or entirely in combination with at least part of the present technique described in other embodiments.

Furthermore, some or all of the techniques may be implemented in combination with other techniques that not described above.

The present technique can also be configured as follows:

(1) An information processing device includes: a reversal processing unit that performs reversal processing on a reversal range in a tree structure representing the geometry of point cloud; and
an encoding unit that encodes geometry data having the tree structure having been subjected to the reversal processing,
wherein the reversal range includes a reversal root node and a descendant node of the reversal root node and is a node range to be subjected to the reversal processing, and
the reversal processing is processing that reverses the bit pattern of a leaf node included in the reversal range and associates the bit pattern of a non-leaf node included in the reversal range with the bit pattern of a child node.

(2) The information processing device according to (1), further including a flag setting unit that sets a bit reversal flag for the reversal root node of the reversal range, the bit reversal flag indicating whether to perform the reversal processing on the reversal range.

(3) The information processing device according to (2), wherein the flag setting unit sets bit reversal flags independently for all the nodes of the tree structure.

(4) The information processing device according to (2), wherein the flag setting unit sets one of the bit reversal flags for the ascendant/descent nodes of the tree structure, and
the ascendant/descent nodes are nodes including nodes having a parent-child relationship in the tree structure.

(5) The information processing device according to (2), wherein the flag setting unit sets one of the bit reversal flags for an entirety of the tree structure.

(6) The information processing device according to any one of (1) to (5), further including a reversal control unit that controls whether to perform the reversal processing.

(7) The information processing device according to (6), wherein the reversal control unit controls whether to perform the reversal processing, on the basis of the encoding efficiency of encoded data of the geometry data.

(8) The information processing device according to (6) or (7), wherein the reversal control unit controls whether to perform the reversal processing, on the basis of the number of points in the reversal range.

(9) The information processing device according to any one of (6) to (8), wherein the reversal control unit controls whether to perform the reversal processing, on the basis of the number of nodes deleted by the reversal processing.

(10) The information processing device according to any one of (1) to (9), wherein the reversal processing unit deletes the node of the bit pattern including only 0 after the reversal processing is performed.

(11) The information processing device according to (10), wherein the reversal processing unit deletes the node of the bit pattern indicating sparse points after the reversal processing is performed.

(12) The information processing device according to any one of (1) to (11), wherein the reversal processing unit performs the reversal processing after the generation of the node in a region including no points in the reversal range.

(13) An information processing method includes: performing reversal processing on a reversal range in a tree structure representing the geometry of point cloud; and encoding geometry data having the tree structure having been subjected to the reversal processing,
wherein the reversal range includes a reversal root node and a descendant node of the reversal root node and is a node range to be subjected to the reversal processing, and
the reversal processing is processing that reverses the bit pattern of a leaf node included in the reversal range and associates the bit pattern of a non-leaf node included in the reversal range with the bit pattern of a child node.

(14) An information processing device including a decoding unit that decodes encoded data of the geometry data of point cloud, and a reversal processing unit that performs reversal processing on a reversal range in a tree structure representing the geometry of the point cloud, the geometry being included in the geometry data obtained by decoding,
wherein the reversal range includes a reversal root node and a descendant node of the reversal root node and is a node range to be subjected to the reversal processing, and
the reversal processing is processing that reverses the bit pattern of a leaf node included in the reversal range and associates the bit pattern of a non-leaf node included in the reversal range with the bit pattern of a child node.

(15) The information processing device according to (14), further including a reversal control unit that controls whether to perform the reversal processing.

(16) The information processing device according to (15), wherein the reversal control unit controls whether to perform the reversal processing on the basis of bit reversal flags indicating whether to perform the reversal processing on the reversal range, the bit reversal flags being set for all the nodes of the tree structure.

(17) The information processing device according to (15), wherein the reversal control unit controls whether to perform the reversal processing on the basis of one bit reversal flag indicating whether to perform the reversal processing on the reversal range, the one bit reversal flag being set for the ascendant/descent nodes of the tree structure.

(18) The information processing device according to (15), wherein the reversal control unit controls whether to perform the reversal processing on the basis of one bit reversal flag indicating whether to perform the reversal processing on the reversal range, the one bit reversal flag being set for the overall tree structure.

(19) The information processing device according to any one of (14) to (18), further including a geometry construction unit that constructs the geometry of a three-dimensional space by using the tree structure having been subjected to the reversal processing.

(20) An information processing method including: decoding encoded data of geometry data of point cloud; and
performing reversal processing on a reversal range in a tree structure representing the geometry of the point cloud, the geometry being included in the geometry data obtained by decoding,
wherein the reversal range includes a reversal root node and a descendant node of the reversal root node and is a node range to be subjected to the reversal processing, and
the reversal processing is processing that reverses the bit pattern of a leaf node included in the reversal range and associates the bit pattern of a non-leaf node included in the reversal range with the bit pattern of a child node.

### REFERENCE SIGNS LIST

100 Geometry encoding device
101 Octree generation unit
102 Initialization unit
103 Bit reversal control unit
104 Flag setting unit
105 Reversal processing unit
106 Encoding unit
200 Geometry decoding device
201 Decoding unit
202 Initialization unit
203 Bit reversal control unit
204 Reversal processing unit
205 Geometry construction unit
500 Point cloud encoding device
501 Geometry encoding unit
502 Geometry decoding unit
503 Point cloud generation unit
504 Attribute encoding unit
505 Bitstream generation unit
600 Point cloud decoding device
601 Extraction unit
602 Geometry decoding unit
603 Attribute decoding unit
604 Point cloud generation unit
800 3D Occupancy Grid map encoding device
801 3D Occupancy Grid map generation unit
802 Transformation unit
803 Point cloud encoding unit
850 3D Occupancy Grid map decoding device
851 Point cloud decoding unit
852 Inverse transformation unit
900 Computer

1. An information processing device comprising:
a reversal processing unit that performs reversal processing on a reversal range in a tree structure representing a geometry of point cloud; and
an encoding unit that encodes geometry data having the tree structure having been subjected to the reversal processing, wherein
the reversal range includes a reversal root node and a descendant node of the reversal root node and is a node range to be subjected to the reversal processing, and
the reversal processing is processing that reverses a bit pattern of a leaf node included in the reversal range and associates a bit pattern of a non-leaf node included in the reversal range with a bit pattern of a child node.

2. The information processing device according to claim 1, further comprising a flag setting unit that sets a bit reversal flag for the reversal root node of the reversal range, the bit reversal flag indicating whether to perform the reversal processing on the reversal range.

3. The information processing device according to claim 2, wherein the flag setting unit sets bit reversal flags independently for all nodes of the tree structure.

4. The information processing device according to claim 2, wherein the flag setting unit sets one of the bit reversal flags for ascendant/descent nodes of the tree structure, and
the ascendant/descent nodes are nodes including nodes having a parent-child relationship in the tree structure.

5. The information processing device according to claim 2, wherein the flag setting unit sets one of the bit reversal flags for an entirety of the tree structure.

6. The information processing device according to claim 1, further comprising a reversal control unit that controls whether to perform the reversal processing.

7. The information processing device according to claim 6, wherein the reversal control unit controls whether to perform the reversal processing, on a basis of encoding efficiency of encoded data of the geometry data.

8. The information processing device according to claim 6, wherein the reversal control unit controls whether to perform the reversal processing, on a basis of the number of points in the reversal range.

9. The information processing device according to claim 6, wherein the reversal control unit controls whether to perform the reversal processing, on a basis of the number of nodes deleted by the reversal processing.

10. The information processing device according to claim 1, wherein the reversal processing unit deletes a node of the bit pattern including only 0 after the reversal processing is performed.

11. The information processing device according to claim 10, wherein the reversal processing unit deletes the node of the bit pattern indicating sparse points after the reversal processing is performed.

12. The information processing device according to claim 1, wherein the reversal processing unit performs the reversal processing after generation of a node in a region including no points in the reversal range.

13. An information processing method comprising:
performing reversal processing on a reversal range in a tree structure representing a geometry of point cloud; and
encoding geometry data having the tree structure having been subjected to the reversal processing, wherein
the reversal range includes a reversal root node and a descendant node of the reversal root node and is a node range to be subjected to the reversal processing, and
the reversal processing is processing that reverses a bit pattern of a leaf node included in the reversal range and associates a bit pattern of a non-leaf node included in the reversal range with a bit pattern of a child node.

14. An information processing device comprising:
a decoding unit that decodes encoded data of geometry data of point cloud, and
a reversal processing unit that performs reversal processing on a reversal range in a tree structure representing a geometry of the point cloud, the geometry being included in the geometry data obtained by decoding, wherein
the reversal range includes a reversal root node and a descendant node of the reversal root node and is a node range to be subjected to the reversal processing, and
the reversal processing is processing that reverses a bit pattern of a leaf node included in the reversal range and associates a bit pattern of a non-leaf node included in the reversal range with a bit pattern of a child node.

15. The information processing device according to claim 14, further comprising a reversal control unit that controls whether to perform the reversal processing.

16. The information processing device according to claim 15, wherein the reversal control unit controls whether to perform the reversal processing on a basis of bit reversal flags indicating whether to perform the reversal processing on the reversal range, the bit reversal flags being set for all the nodes of the tree structure.

17. The information processing device according to claim 15, wherein the reversal control unit controls whether to perform the reversal processing on a basis of one bit reversal flag indicating whether to perform the reversal processing on the reversal range, the one bit reversal flag being set for ascendant/descent nodes of the tree structure.

18. The information processing device according to claim 15, wherein the reversal control unit controls whether to perform the reversal processing on a basis of one bit reversal flag indicating whether to perform the reversal processing on the reversal range, the one bit reversal flag being set for the overall tree structure.

19. The information processing device according to claim 14, further comprising a geometry construction unit that constructs a geometry of a three-dimensional space by using the tree structure having been subjected to the reversal processing.

20. An information processing method comprising:
decoding encoded data of geometry data of point cloud; and
performing reversal processing on a reversal range in a tree structure representing a geometry of the point cloud, the geometry being included in the geometry data obtained by decoding, wherein
the reversal range includes a reversal root node and a descendant node of the reversal root node and is a node range to be subjected to the reversal processing, and
the reversal processing is processing that reverses a bit pattern of a leaf node included in the reversal range and associates a bit pattern of a non-leaf node included in the reversal range with a bit pattern of a child node.
